(19) United States
(12) Patent Application Publication
(10) Pub. No.: US 2012/0212963 A1
(43) Pub. Date: Aug. 23, 2012

(54) APPARATUS AND METHOD FOR OPERATING A PORTABLE XENON ARC SEARCHLIGHT

(75) Inventor: Gregory Z. Jigamian, Temecula, CA (US)

(73) Assignee: SureFire LLC, Fountain Valley, CA (US)

(21) Appl. No.: 13/033,554

(22) Filed: Feb. 23, 2011

(51) Int. Cl. F21V 14/04; F21V 9/00

(52) U.S. Cl. 362/263; 362/280; 250/504 H

(57) ABSTRACT

An apparatus for producing a high intensity beam of light with high efficiency of conversion of electrical power into light intensity includes an arc lamp, a reflector, a screw drive mechanism coupled between the arc lamp and reflector for positioning the arc lamp relative to the reflector to provide zoom control of the beam of light, and a spring for biasing the screw drive mechanism into a stable configuration to eliminate backlash and instability of the positioning the arc lamp relative to the reflector to provide zoom control of the beam of light. A handheld light includes an IR filter selectively disposable over the aperture of the light so that only infrared light and a circumferential light curtain is interposed between the IR filter and the body so that no there are no light leaks even the IR filter and the body are prevented from fitting closely due to interposed debris.

### BACKGROUND OF INVENTION

1. Field of the Invention

The invention relates to xenon arc lamps and in particular to compact or handheld xenon short arc searchlights or illumination systems.

2. Description of Prior Art

Handheld lighting devices with focused beams or spotlights or searchlights, whether battery-powered or line-powered, are commonly used by military, law enforcement, fire and rescue personnel, security personnel, hunters and recreational boaters among others for nighttime surveillance in any application where a high intensity spotlight is required. The conditions of use are highly varied, but generally require the light to deliver a desired field of view at long distances, be reliable, durable and field maintainable in order for it to be practically used in the designed applications. Typically the light is hand carried and must be completely operable using simple and easily access manual controls which do not require the use of two hands. However, in fact actual units, such as the NightHunters described below, can only be turned on and off with one-hand control and two hands must be used in order to operate the zoom focus.

One supplier of such handheld or mountable lighting devices is Xenonics Holdings, Inc., 3186 Lionshead Avenue, Carlsbad, Calif. 92010, which has manufactured devices under the names, NightHunter, NightHunter One, NightHunter 2 NightHunter 2 and NightHunter 3. Like many prior art handheld lighting devices, these products include a zoom capability where the degree of focus or collimation of the light beam can be varied. This is achieved by advancing or retracting the housing of the light reflector, which carries the reflector, with respect to the position of the plasma ball in the xenon arc lamp in the device. The housing and its carried reflector is relatively moved axially along the optical axis of the reflector by means of a screw drive or a rotatable threaded coaxial connection between a unit holding the arc lamp and the reflector housing. Movement of the focal point of the reflector elative to the plasma ball or center or the origin of the light from the arc lamp changes the degree of collimation of the light thrown by the reflector.

The light beam may extend an order of a mile with functional light intensity in the spotlight, so that very small changes in the degree of collimation of the light beam cause large changes in the size of the spot at such distances, A correspondingly small change in the relative position of the focal point of the reflector relative to the plasma ball or center or the origin of the light from the arc lamp causes corresponding changes in the degree of collimation provided by the reflector to the light beam. Therefore, small instabilities of any kind in the NightHunter in the relative position of the focal point of the reflector relative to the plasma ball or center or the origin of the light from the arc lamp cause similar instabilities in the degree of collimation which are greatly magnified into instabilities of the size and location of the spot that is projected at large distances.

In the case of the NightHunter, NightHunter One, NightHunter 2 , and NightHunter 3, for example, there is no stability control provided for the rotatable threaded coaxial connection between a unit holding the arc lamp and the reflector housing, resulting in unmanageable instabilities in the size and location of the spot that is projected at large distances. When the NightHunter is subject to vibrations, which is always the case when the light is mounted on a vehicle or firing gun mount of any kind, the size of the spot projected at large distances fluctuates wildly and out of control, making the level of illumination on the target unstable and target identification difficult. This is a material inherent defect in the NightHunter designs, since one of the device's primary uses is intended to be for gun mounts for night firing.

Still further the inherent backlash in the screw drive results in a lag in the zoom control when the direction of zoom is changed which is perceived by the user as an inaccuracy of adjustment, or nonresponsiveness in the control when the direction of zoom is changed.

Further, the clearance in the zoom control threading of the NightHunter not only allows the center of focus of the reflector and the plasma ball of lamp to be displaced from each other both in generally forward and reverse direction of the optical axis of the reflector, thereby causing the degree of collimation of the beam to uncontrollably fluctuate, but also to allow the optical axis of the reflector to become uncontrollably inclined relative to the desired axis of the gun mount or reflector direction. This latter error causes the light beam to be centered at a location other than where the gun is aimed. While this uncontrolled position and orientation of the center of focus and optical axis of the reflector, caused by the looseness or inherent thread clearance between the reflector and its head or mounting, is small, its effect as seen in the performance at the beam at typical operating distances is a material defect and clearly noticeable, The uncontrollable performance is aggravated when the light is mounted in a high vibrational environment, such as on a firing gun mount, where every gun discharge can potentially and does reconfigure the optical focal point and optical axis of the reflector from its prior position and orientation.

Further, even without the presence of mechanical vibrations the thermal heating caused by the hot arc lamp in the NightHunter will change the relative position of the focal point of the reflector relative to the plasma ball or center or the origin of the light from the arc lamp and cause the size of projected spot to drift. This inherent problem of the NightHunter designs is particularly exacerbated in cold night combat situations during which the hot lamp may be focused on a target and then turned off, The cooling during the off phase is sufficient to materially change the relative position of the focal point of the reflector relative to the plasma ball or center or the origin of the light from the arc lamp, so that when the cold lamp is turned back on, the previously focused spot no longer has the same size and hence illumination intensity on the target has changed as compared to what it was when it was last turned off. Then during the next use cycle, the spot size drifts again.

Still further, in the NightHunter 3 an IR filter is hinged to swing over the aperture of a handheld flashlight or torch to allow for clandestine IR night illumination. The IR filter rotates a flat round filter frame over the aperture of the flashlight so that only IR and not visible light can be radiated from the flashlight for the intended clandestine illumination. However, in the field any intrusion of sand, dirt or other debris on the juxtaposed flat surfaces of either the IR filter or the flashlight results in a small spacing or crack between the two, which is particularly magnified if the debris is near the hinge, through which crack a substantial amount of white light can leak making the user of the IR torch very visible.

Further, there is no means which conveniently allows the user of the NightHunter 3 to know that the light is on when the IR filter is in place. Unless the user happens to have IR night vision googles on and operating, it is possible to unknowingly open the IR filter with the torch on, resulting in a strong unintended display of white light.

Further yet, the IR filter in the NightHunter 3 is hinged so that, when in its fully open position, the IR filter is cantilevered out from the body of the torch at nearly right angles to the torch, making use of the torch in the non-IR mode very awkward.

What is needed is a solution which overcomes the foregoing inherent and material defects of the NightHunter designs.

It is to be expressly understood that the teachings of this invention are relevant to the entire range of NightHunter designs having this type of zoom control, so that the following patents are herein incorporated by reference: Portable device for viewing and imaging U.S. Pat. No. 7,581,852; Portable searchlight, U.S. Des. Pat. D590,972; Long-range, handheld illumination system, U.S. Pat. No. 7,344,268; Apparatus and method for operating a portable xenon arc searchlight, U.S. Pat. No. 6,909,250; Apparatus and method for operating a portable xenon arc searchlight, U.S. Pat. No. 6,896,392; Portable focused beam searchlight, U.S. Des. Pat. 0490,924; Apparatus and method for operating a portable xenon arc searchlight, U.S. Pat. No. 6,702,452; and Portable focused beam searchlight, U.S. Des. Pat. D425,643.

### BRIEF SUMMARY OF THE INVENTION

The illustrated embodiments of the invention include an apparatus for producing a high intensity beam of light with high efficiency of conversion of electrical power into light intensity comprising an arc lamp, a reflector, a screw drive mechanism coupled between the arc lamp and reflector for positioning the arc lamp relative to the reflector to provide zoom control of the beam of light, and a spring for biasing the screw drive mechanism into a stable configuration to eliminate backlash and instability of the positioning the arc lamp relative to the reflector to provide zoom control of the beam of light.

In another embodiment what is provided is an apparatus for efficiently producing a high intensity narrow, substantially collimated beam of light which includes a user adjustable zoom comprising an arc lamp having a plasma which is characterized by a longitudinal arc in which the light is produced, a reflector surrounding the lamp, the reflector having a longitudinal optical axis and a focal range from which light is reflected within a predetermined range of collimation of the beam of light, the plasma of the arc lamp being positioned on the optical axis within the focal range, a threaded coupling between the lamp and reflector so that longitudinal position of the reflector relative to the arc lamp is adjustable while in use; wherein the reflector is longitudinally displaceable relative to the lamp by means of rotation about the threaded coupling so that the reflector is longitudinal displaced along the optical axis while maintaining the plasma of the lamp on the longitudinal optical axis within the focal range, a lamp housing and wherein the lamp is fixed within the lamp housing, the reflector being coupled to the lamp housing and longitudinally displaceable with respect to the lamp housing; the lamp housing having a shoulder in sliding juxtaposition with the reflector to maintain the reflector on the longitudinal optical axis as the reflector is longitudinal displaced by means of rotation about the threaded coupling, and a spring for biasing the threaded coupling into a stable configuration to eliminate backlash and instability of the positioning the arc lamp relative to the reflector to provide zoom control of the beam of light.

The reflector has a direction of projection of the beam of light and wherein the lamp has an anode and a cathode, the anode being oriented on the longitudinal optical axis relative to the cathode so that the anode is rearwardly positioned in the reflector relative to the cathode and the direction of projection of the beam of light by the reflector.

In yet another embodiment, what is included is an apparatus for producing an adjustable high intensity, narrow, substantially collimated which includes a user adjustable zoom beam of light comprising an xenon or metal halide arc lamp which is characterized by a short longitudinal arc, a reflector surrounding the lamp, the reflector having a longitudinal optical axis and a focal range on the longitudinal optical axis from which light is reflected within a predetermined range of collimation of the beam of light, a threaded coupling between the lamp and reflector; wherein the reflector is longitudinally displaceable relative to the lamp while in use so that the reflector longitudinally displaced by means of rotation about the threaded coupling while in use and while maintaining the arc lamp on the longitudinal optical axis within the focal range, a lamp holder having a shoulder in sliding juxtaposition with the reflector to maintain the reflector on the longitudinal optical axis as the reflector is longitudinal displaced by means of rotation about the threaded coupling, and a spring for biasing the threaded coupling into a stable configuration to eliminate backlash and instability of the positioning the arc lamp relative to the reflector to provide zoom control of the beam of light.

In still another embodiment of the invention what is included is an apparatus for producing a high intensity substantially collimated uniform beam of light comprising an arc lamp having a plasma which is characterized by a longitudinal arc in which the light is produced, a reflector surrounding the lamp, the reflector having a longitudinal optical axis and a focal range from which light is reflected within a predetermined range of collimation of the beam of light, the plasma of the arc lamp being positioned on the optical axis within the focal range, wherein the reflector is longitudinally displaceable by user manipulation relative to the lamp so that the reflector is longitudinally displaced along the optical axis while maintaining the plasma of the lamp on the longitudinal optical axis within the focal range, wherein the reflector has a direction of projection of the beam of light, and wherein the lamp has an anode and a cathode, the anode being oriented on the longitudinal optical axis relative to the cathode so that the anode is rearwardly positioned in the reflector relative to the cathode and the direction of projection of the beam of light by the reflector, whereby the field of illumination of the beam of light is rendered more uniform, and a spring for biasing the reflector and lamp into a stable relative configuration to eliminate backlash and instability of the positioning the arc lamp relative to the reflector to provide zoom control of the beam of light.

The apparatus is a light, further comprising a light housing to which the arc lamp is stationarily mounted, a reflector housing to which the reflector is mounted, a reflector positioner comprising a threaded coupling between the light housing and the reflector housing enabling longitudinal displacement of the reflector relative to the light housing by the user manipulation; and a fluted heat sink mounted on the light housing, wherein the housing conductively dissipates lamp heat from the anode,

One embodiment includes a searchlight for producing a narrow, substantially collimated beam which includes a user adjustable zoom comprising a lamp which is characterized by a short longitudinal arc, a lamp circuit coupled to the lamp for powering and controlling illumination produced by the lamp, a reflector disposed about the lamp to reflect light generated by the lamp in a forward direction, and which reflector is characterized by a longitudinal axis extending rearwardly and forwardly, a reflector positioner comprising a threaded coupling between the reflector and a housing of the searchlight so that the reflector is selectively displaced with respect to the housing by means of rotation about the threaded coupling while in use and while the lamp remains fixed relative to the housing; the lamp having an anode and a cathode, the anode being positioned rearwardly along the longitudinal axis relative to the cathode, whereby the field of illumination of the beam of light is rendered more uniform; and a fluted heat sink fixed on the housing to conductively dissipate lamp heat from the anode, and a spring for biasing the thread coupling into a stable configuration to eliminate backlash and instability of the positioning the arc lamp relative to the reflector to provide zoom control of the beam of light.

The illustrated embodiments also include a handheld light including a source of light having infrared (IR) and visible spectra, a body having an aperture through which light from the source is transmitted, an IR filter selectively disposable over the aperture so that only infrared light is selectively transmitted through the aperture, and a circumferential light curtain interposed between the IR filter and the body. When the IR filter is selectively disposed over the aperture, no light is able to leak between the IR filter and the body even when a granular object, such a sand, microgravel, dirt or other debris, is disposed between the IR filter and the body and prevents close fitting between the IR filter and the body. The light curtain sufficiently extends between the IR filter and the body to block light from leaking between the IR filter and the body when the granular object is disposed between the IR filter and the body.

The IR filter is coupled to the body by a hinge allowing rotation of the IR filter. The hinge is arranged and configured relative to the body to allow the IR filter to be rotated into an open configuration where the aperture is not covered by the IR filter and to be rotated into a position folded back toward the longitudinal axis of the body.

The handheld light further includes a magnetic latch. The IR filter is selectively maintained in a closed configuration by the magnetic latch.

The handheld light further includes a control circuit and an indicator lamp mounted on the body and coupled to the control circuit. The indicator lamp is operative when the light source is lit, so that a user may determine by observation of the indicator lamp whether the light source is lit even though the IR filter is disposed over the aperture and transmission of visible light therethrough is not otherwise detectable.

While the apparatus and method has or will be described for the sake of grammatical fluidity with functional explanations, it is to be expressly understood that the claims, unless expressly formulated under 35 USC 112, are not to be construed as necessarily led in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a perspective view of the assembled light.

FIG. 1a is a bottom elevational view of the assembled light of FIG. 1.

FIG. 1b is a rear elevational view of the assembled light of FIGS. 1 and 1a.

FIG. 2 is a side cross-sectional view of the light of FIG. 1 showing the interior components in an assembled configuration.

FIGS. 3a-3d are depictions of the anode-rear positioning and the consequent benefit as compared to prior art anode-forward positioning.

FIG. 3a is a depiction of the luminance distribution of an arc from a xenon short arc lamp in a horizontal position.

FIG. 3b is simplified diagram of a parabolic reflector depicting the focal point and high magnification area of the reflector.

FIG. 3c illustrates how anode-rear positioning of a short-arc lamp places the luminance distribution in the high magnification area of the reflector,

FIG. 3d is a graphical comparison of the illuminance of a 75 W xenon short arc lamp in an anode-rear verses anode-forward position.

FIG. 4 is a partially cutaway bottom view of the light of FIG. 1 showing the relationship of the battery, the circuit board, the lamp and the reflector in an assembled configuration.

FIG. 5 is a simplified exploded view of selected components of the searchlight of the invention.

FIG. 6 is a perpendicular cross-sectional view of the searchlight of the invention as seen through section lines 5-5 of FIG. 2.

FIG. 7 is a perpendicular cross-sectional view of the searchlight of the invention as seen through section lines 6-6 of FIG. 2.

FIG. 8 is a simplified graph of the current as a function of time in a xenon arc lamp.

FIG. 9 is a simplified graph of the voltage as a function of time in a xenon arc lamp.

FIG. 10 is a simplified schematic diagram of the pulse width modulator, converter and ignition circuit of the arc lamp of the invention.

FIG. 11 is a simplified schematic diagram of the power supply circuit of the invention.

FIG. 12 is a simplified schematic diagram of a lamp current sensing circuit of the arc lamp of the invention.

FIG. 13 is a simplified schematic diagram of a reference voltage circuit of the invention.

FIG. 14 is a simplified schematic diagram of a programmed logic device in the circuit of amp of the invention.

FIG. 15 is a simplified schematic diagram of a battery charging circuit of the arc lamp of the invention,

FIG. 16 is a side cross-sectional view of a printed circuit board showing multiple conductive paths for high current circuit segments.

FIG. 17 is an exploded perspective view of the improvement of the illustrated embodiment wherein stability is provided to the zoom control of the device.

FIG. 18 is a side cross view of the embodiment shown in FIG. 17.

FIG. 19 is a perspective view of the prior art NightHunter 3 with the IR filter in its fully open configuration.

FIG. 20a is side elevational view of the upper end of the prior art NightHunter 3 with the IR filter in its fully closed configuration.

FIG. 20b is an enlarged side cross sectional view of the portion in zone B of FIG. 20c of the upper portion of the prior art NightHunter 3 with the IR filter in its fully open configuration.

FIG. 20c is a side cross sectional view taken through section lines A-A of FIG. 20a of the upper portion of the prior art NightHunter 3 with the IR filter n its fully open configuration.

FIG. 21 is a side cross sectional view of the improved embodiment of the invention over the NightHunter 3 corresponding to the enlargement of FIG. 20b.

FIG. 22 is side elevational view of the improved embodiment of the invention over the NightHunter 3 with the IR filter in its fully open configuration folded back toward the body of the torch.

FIG. 23a is side elevational view of the upper end of the improved embodiment of the invention over the NightHunter 3 with the IR filter in its fully closed configuration.

FIG. 23b is a side cross sectional view taken through section lines C-C of FIG. 23a of the upper portion of the improved embodiment of the invention over the NightHunter 3 with the IR filter in its fully closed configuration.

FIG. 23c is an enlarged side cross sectional view of the portion in zone E of FIG. 23b of the upper portion of the improved embodiment of the invention over the NightHunter 3 with the IR filter in its fully closed configuration.

FIG. 23d is an enlarged side cross sectional view depiction of another embodiment wherein the light trap is provided by a circular ridge defined on the end surface, which is disposed into a circular groove defined into frame in an open tongue-in-groove configuration.

FIG. 24 is a bottom plan view of the torch of FIG. 22 showing the indicator lights for the operational status of the torch and its charged condition.

FIG. 25 is a diagram which illustrates the source of uncontrolled collimation errors and directional control of the beam in the NightHunter 3, which are overcome by the embodiments of the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF PREFERRED EMBODIMENTS

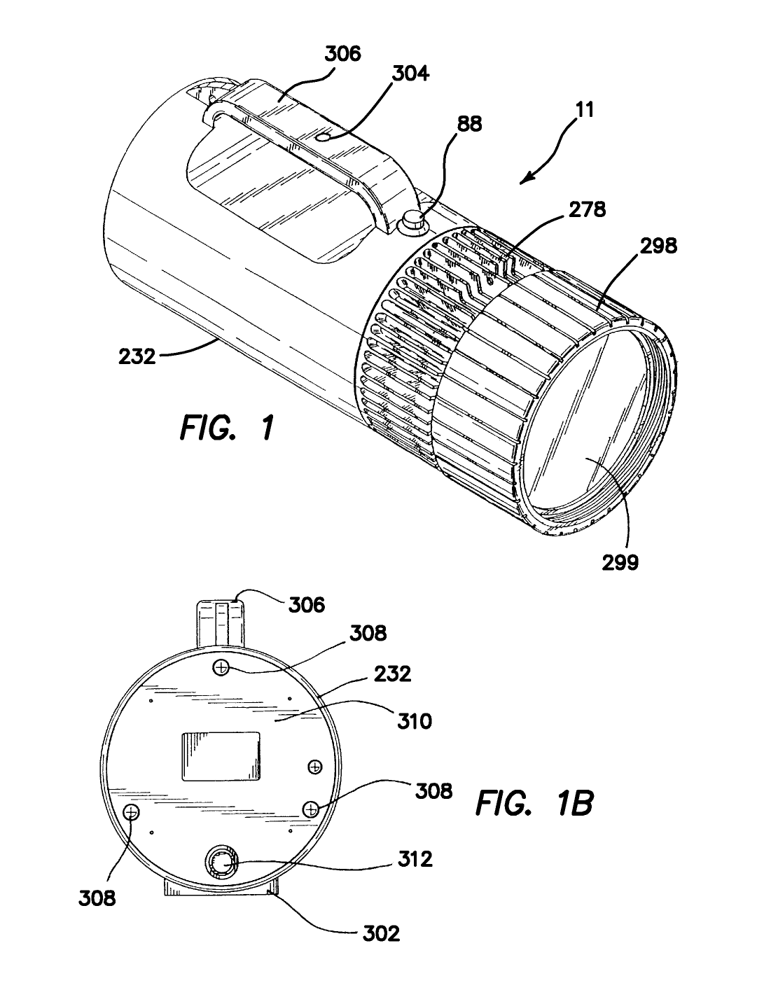

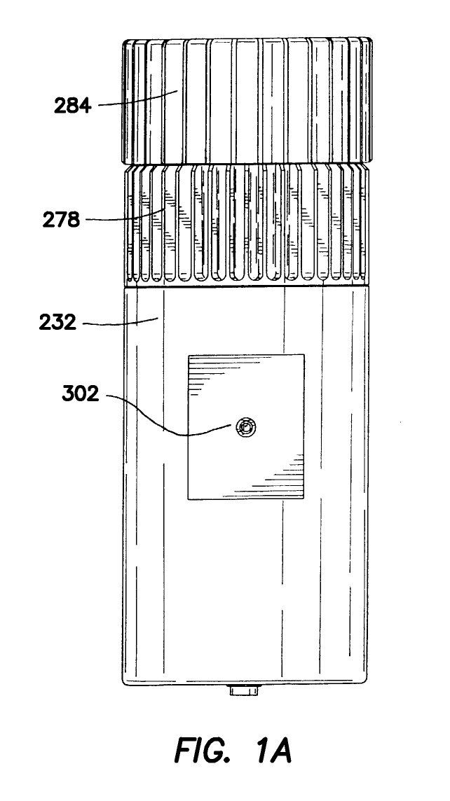

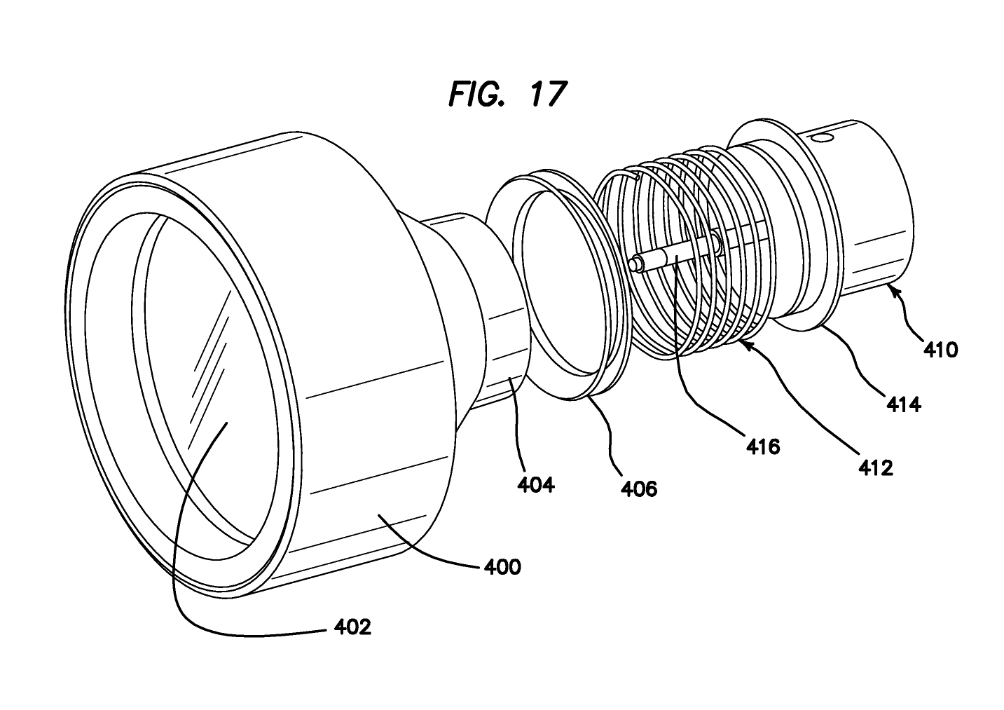

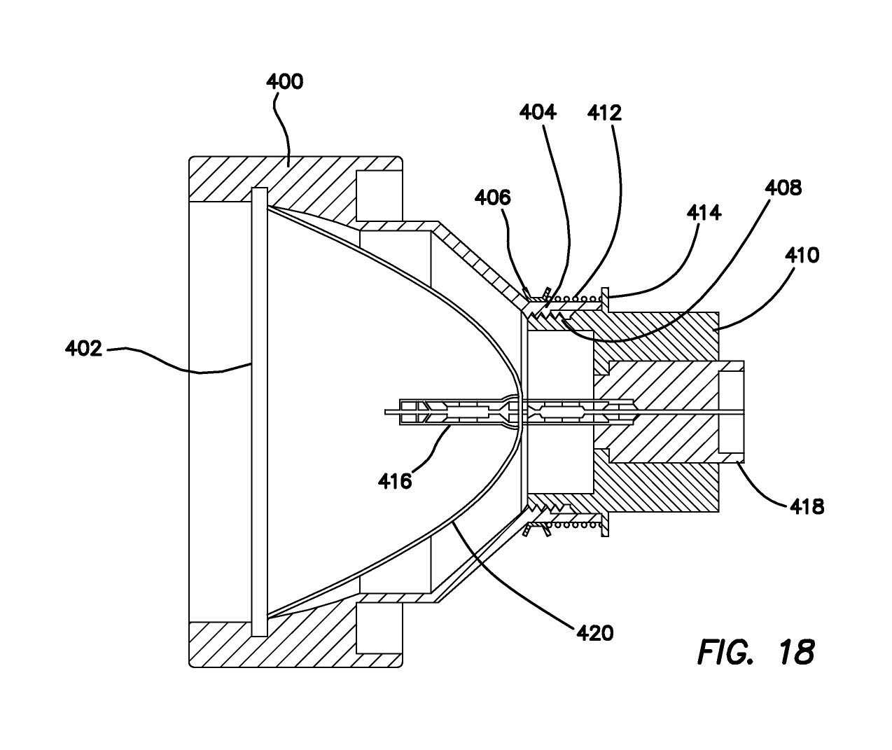

The illustrated embodiment of the NightHunter is described below in connection with FIGS. 1-16 as set out in U.S. Pat. No. 6,702,452 incorporated herein and reproduced below. The improvement of the illustrated embodiment is illustrated in FIGS. 17 and 18 and is incorporated into any handheld light having zoom control, including but not limited to the designs of and designs Ike the NightHunter or NightHunter One, NightHunter 2, and NightHunter 3.

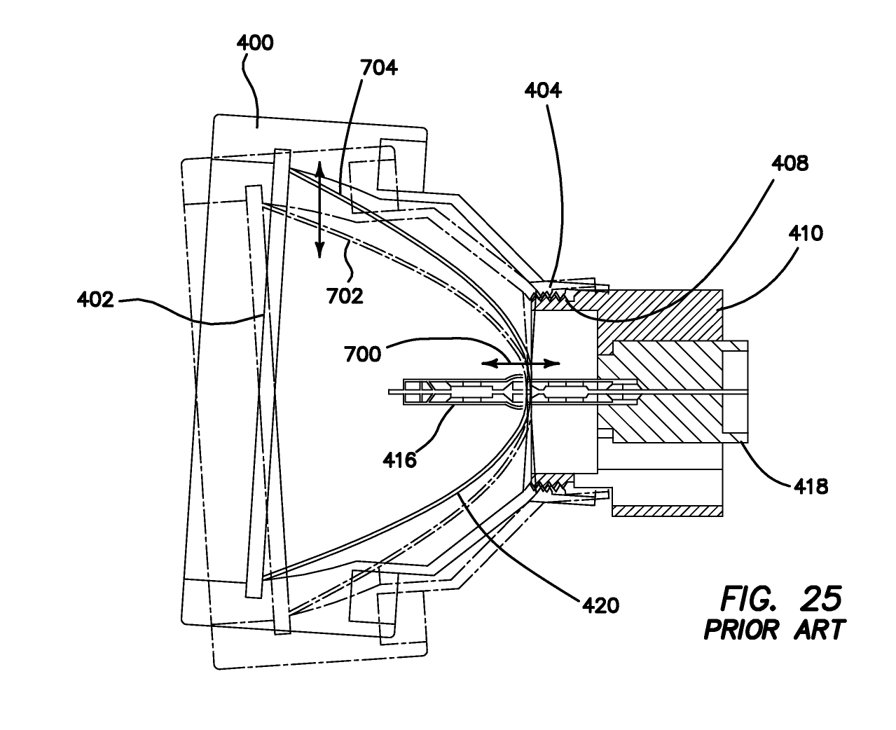

FIG. 25 is a diagram illustrating the source of the uncontrolled zoom and collimation defects and directional control defects, which characterize the NightHunter. FIG. 25 is the same reflector and lamp housing or head arrangement as discussed below in FIG. 17, but the spring 412 and associated structure below is missing. FIG. 25 illustrates, in exaggerated depiction, that the inherent clearance in threading 408 of the NightHunter causes the focal point of reflector 420 to be uncontrollably positioned in a forward and rearward direction symbolically represented by arrow 700 relative to the plasma ball in lamp 416. This results in an uncontrollable variation in the collimation or control of zoom of the light beam in the NightHunter, particularly when the light is jarred by impulsive vibrations from a firing gun to which is mounted. Similarly, the inherent clearance in the threading 408 allows the optical axis of reflector 420 to wander uncontrollable in a cone of angles indicated symbolically in exaggerated depiction by outlines 702 and 704 of reflector housing 400 corresponding to orientation limits of the cone. In actuality both the reflector housing 400 and/or lamp housing 410 may move in any direction relative to the intended aim of the gun or desired direction of the optical axis and position of the focal center of reflector 420. The impulsive vibrations of the gun transmitted to the light or reflector head, i.e. to threaded coupling 408, allows the optical axis of reflector 420 to cant uncontrollably from one direction to another within a solid cone of angles. Smaller clearances in threading 408 increases manufacturing difficulties and cost and further invites galling of the threads 408 when the reflector housing 400 and lamp housing 410 are screwed together or apart during field maintenance or use.

FIG. 17 shows in exploded perspective view of the reflector housing 400 with faceplate 402 mounted therein. The rear end of housing 400 terminates a hub 404 in which internal threading 408 is defined as best seen in the side cross sectional view of FIG. 18. Exterior matching threading, also denoted by reference numeral 408, is defined on the external of a coupling forward end of lamp housing 410 shown in FIG. 18. A thrust bearing washer 406 best seen in FIG. 17 slidingly slips over hub 404 and provides a bearing surface against which the forward end of a resilient member, such as a coil compression spring 412 bears. The opposing end of spring 412 bears against a flange 414 extending from lamp housing 406. A lamp holder and socket 418 is coaxially disposed in lamp housing 406 and provides for a mechanical and electrical connection to arc lamp 416.

It may be readily appreciated that if lamp housing 406 is rotated relative to reflector housing 400, that lamp housing 406 will be advanced or retracted in a directional parallel to the optical axis of reflector 420 mounted in housing 400, depending on the sense of rotation. However, the thread clearance which exists and is designed into threading 408 coupling lamp housing 419 and reflector housing 400 in order to allow for free relative rotation of the threaded housings 400 and 410 does not give rise to an associated backlash when the sense of rotation changes or to relative positional instability due to mechanical vibrations or thermal expansion or contraction of the components. Spring 412 biases the threading 408 into a predetermined relative configuration regardless of backlash, vibration or thermal variation. In the illustrated embodiment spring 412 serves to maintain the rear surfaces of threading 408 on the lamp housing 410 in stable and constant contact with the front surfaces of threading 408 on the reflector housing 400. However, it is entirely within the scope of the invention that different biasing configurations in the screw drive could be maintained at all times or even at different times, if desired, and the same stability of a configuration of the screw drive can be achieved. The stiffness of spring 412 is chosen such that all practically encountered vibrations or thermal variations are overcome by or substantially less than the spring force and have no effect on the relative position of housings 400 and 410 and hence no effect on the relative position of the focal point of the reflector relative to the plasma ball or center or the origin of the light from the arc lamp and the control of the size of projected spot.

The spot size and hence the intensity of the light on the target remains stable regardless of how much the vehicle or gun shakes or vibrates. The spot size remains at its last chosen magnitude regardless of the thermal or operational cycling of the light and thermal heating or cooling effects. The zoom control begins to respond immediately with the activation of the zoom control so that collimation of the light beam is changed as soon as the zoom control is activated, regardless of whether it is increasing or decreasing and without any time lag. In this manner the material and inherent defects of each of the NightHunter spotlights and other spotlights with a screw drive zoom mechanism are eliminated.

A xenon arc searchlight or illumination device incorporates a circuit that both provides for lamp ballasting and charging of the system battery from an external power source. The tolerance to variations in the system supply voltage as well as external voltage are increased by providing logic control of the converter circuit through a programmed logic device (PLD). The intensity of the arc lamp is smoothly decreased or increased in a continuous manner from a maximum intensity to a minimum intensity beam. Ignition of the lamp at its minimum illumination levels is thereby permitted. The lamp beam is narrowed or spread by relative movement of a reflector with respect to the lamp by advancing or retracting the reflector along its optical axis of symmetry on which the lamp is also aligned. The reflector has short focal length of the order of magnitude of approximately 0.3-0.4 inch which maximizes collection efficiency and beam collimation. The lamp is designed so that the lamp, reflector and battery assemblies are easily field replaceable without tools. The lamp, ballast, battery and charger are provided in a rugged package which is sealed for field use. The searchlight is combined by an appropriate mounting adaptable with other optical detector devices such as cameras, binoculars and night vision telescopes. The beam output is similarly usable with a combination of filters to allow the most varied intensity and wavelengths for a particular application, such as smoke filled environments, surveillance employing near-infrared or infrared illumination, underwater, ultraviolet or any color in the visible range illumination. The xenon arc lamp is oriented within the searchlight with respect to the reflector to provide the most concentrated and convergent field of illumination on which the lamp is capable, namely with the anode of the lamp turned away from the forward beam direction in the reflector.

FIG. 1 is a perspective view of searchlight 11 which shows a body 232, an integral handle 306 in which a mounting hole 304 is defined, a heat sink 278 and a rotatable bezel 298 in which a faceplate 299 is fixed. Pushbutton switch 88 is disposed into body 232 just forward of handle 306 where a user's thumb would normally be positioned when holding searchlight 11 by handle 306. Pushbutton switch 88 is a sealed momentary contact switch which may be provided with an internal LED which is lit when searchlight 11 is operating and may indicate different modes of operation (on; flashing for charging, solid for full charge, intermittent flash for float charge, etc.). Searchlight 11 is a compact, rugged, and portable battery powered light about the size of a large flashlight or lantern that can produce an adjustably collimated, and adjustable high intensity beam of light for more than a mile in clear atmospheric conditions.

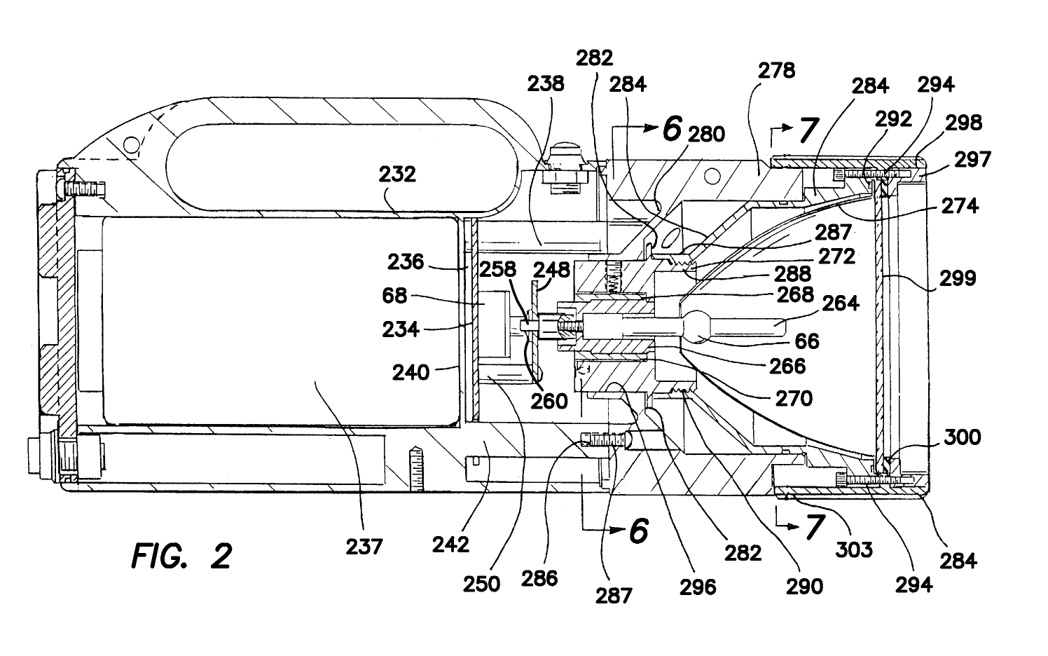

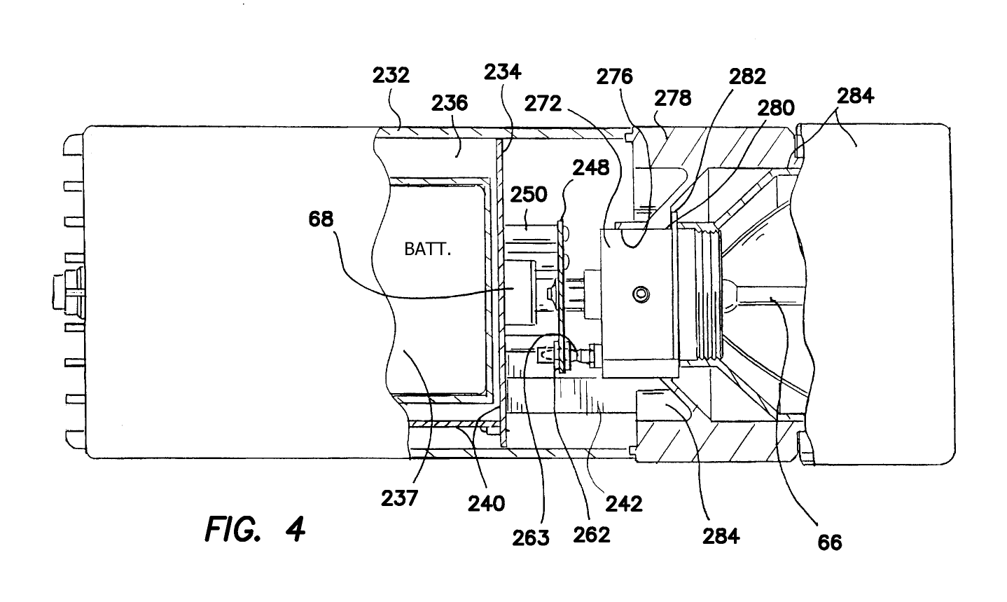

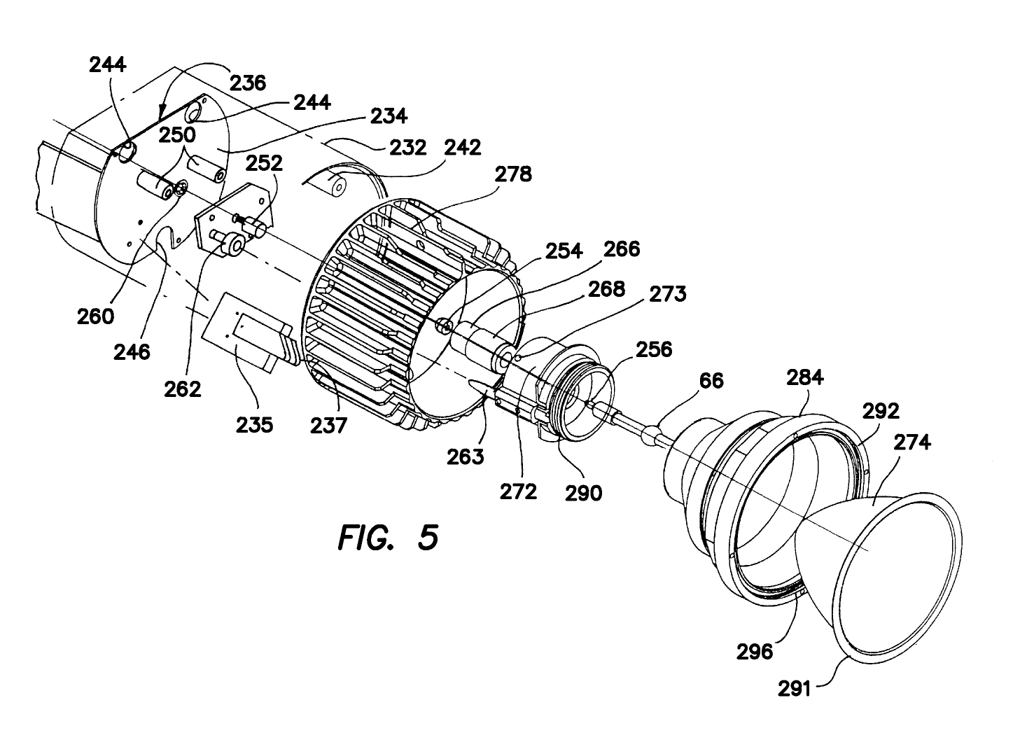

Turn now to the exploded assembly drawing of the mechanic elements of the searchlight 11 as depicted in FIG. 5. Elements of the searchlight 11 have been omitted from the drawings for the sake of simplicity of the illustration. The searchlight 11 includes a housing 232 shown in cut-away perspective view in FIGS. 2 and 4. A base plate 234 is provided behind which is a space 236 which carries the battery 237 for searchlight 11 as shown in FIGS. 2 and 4. Base plate 234 is mounted to housing 232 through molded end standoffs 238 one of which is shown in FIG. 4. The molded battery wall 240 integrally extends through standoffs 242 through holes 244 and U-shaped indentation 246 defined through circuit board 234 shown in FIG. 5.

Battery 237 is accessible through the rear of housing 232 as shown in FIG. 1b. Three screws 308 fasten a circular rear plate 310 to housing 232. A recessed electrical connector 312 is provided in rear plate 310 through which an external power supply may be connected either to operate searchlight 11, to recharge battery 237 or both. Electrical connector 312 is recessed to provide a rugged configuration so that the connector will not be damaged by rough handling.

Housing 232 incorporates a housing mounting hole 302 as shown in FIG. 1a on its bottom surface, an integral handle 306 and a hole 304 defined in handle 306 for receiving a handle mount with a thumb screw (not shown) with which to mount or stack another device such as a camera, binoculars, night vision scope and the like on top of searchlight 11. In this manner two units may be used in combination, namely the searchlight of the invention moved or manipulated as a unit with an optical detection device of some sort. The entire assembly may also be place on a support tripod or mount using the housing mounting hole 302 shown in FIG. 1a.

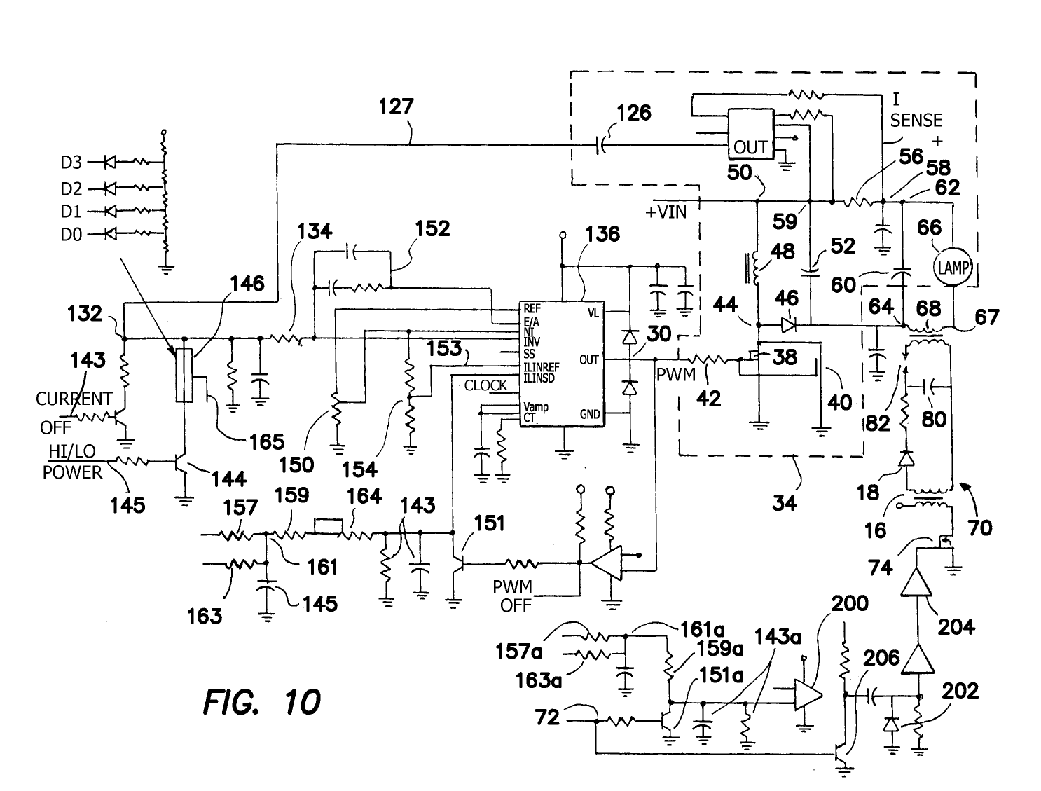

Transformer 68 mounts onto base plate 234. Circuit board 248 is carried on a plurality of standoffs 250, which is shown in FIGS. 2 and 5 for the mounting of a resilient spring assisted connector 252 which engages anode nut 254 disposed onto the anode terminal 256 of xenon lamp 66. The opposing pin 258 of the resilient spring assisted connector 252 shown in FIG. 2 is disposed through circuit board 248 and secured thereto by means of a push nut 260. Pin 258 of the resilient spring assisted connector 252 is then connected by a wire or means not shown to transformer 68. A banana plug receptacle 262 is similarly connected by a wire or means not shown to lamp ground 62 of FIG. 10, Banana plug 263 as shown in FIG. 5 is connected by a wire not shown to the cathode of 264 of lamp 66 shown in FIG. 2 and is plugged into banana plug receptacle 262.

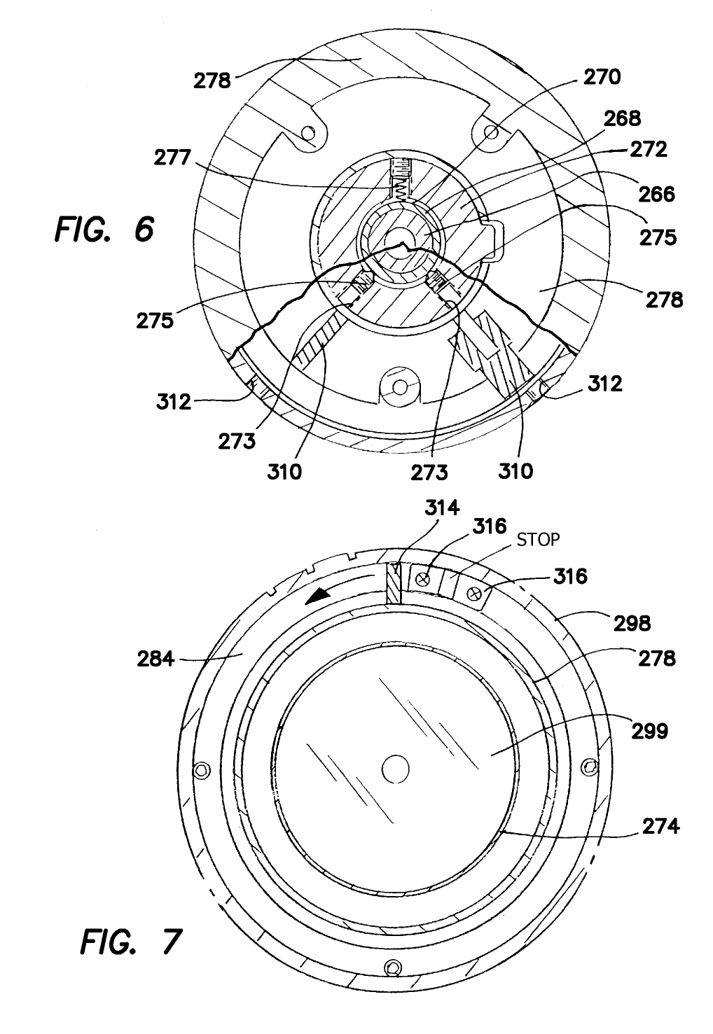

Lamp 66 is disposed in a ceramic sleeve 266 which in turn is affixed into an aluminum jacket 268 as shown in FIG. 5. The aluminum jacket 268 is disposed in a cylindrical cavity 270 defined in lamp base 272. There is sufficient clearance between aluminum sleeve 268 and cylindrical cavity 270 defined in lamp base 272 to allow a limited amount of radial displacement of sleeve 268 about the longitudinal axis of lamp housing 232 which is parallel to the longitudinal axis of symmetry of reflector 274. A pair of access holes 273 through finned heat sink 278 and lamp base 272, which holes 273 are shown in FIG. 6 in lamp base 272, allow access by means of an Allen wrench to two orthogonally positioned socket-head set screws 275 on one side of sleeve 268 and which are each opposed by a spring 277 on the opposite side of sleeve 268 to adjustably center sleeve 268 in lamp base 272. In this manner, the placement of the arc or plasma in lamp 66 can be accurately and easily adjusted in the field if need be in a plane perpendicular to the beam axis to lie precisely on axis. Because lamp base 272 is centered on the optical axis of symmetry of reflector 274 best shown in FIG. 5, lamp 66 can thus be adjusted in the field to be optically aligned onto the axis of symmetry of reflector 274. Hence, the beam of light from lamp 66 can be focused for maximum collimation.

Lamp base 272 is disposed in a cylindrical bore 276 defined in fluted heat sink 278 thus as best visualized in cross-sectional view of FIG. 4. Fluted heat sink 278 also includes bosses 284 which mate with molded standoffs 242 of housing 232 and are connected thereto by screws 286 disposed in threaded bore 287 defined in bosses 284 and standoffs 242 as shown in FIG. 2. Lamp base 272 is disposed into cylindrical bore 276 until radial flange 280 of lamp base 272 makes contact with shoulder 282 of fluted heat sink 278. It will be appreciated from the description below that reflector housing 284 shown in FIG. 5 can be easily detached from the front of searchlight 11 by unscrewing reflector housing 284 from the front of lamp base 272 as best seen in FIG. 4. This then allows lamp base 272 to be withdrawn from cylindrical bore 276, unplugging banana plug 263 from banana socket 262. Lamp 66, ceramic sleeve 266 and aluminum jacket 268 are thus handled as a unit with lamp base 272. If lamp 66 burns out, then it can readily be removed in the field as a unit without special tools or procedures in the manner just described above with the old lamp base 272 and a new lamp base 272 with a new lamp 66, ceramic sleeve 266 and aluminum jacket 268 inserted. This has the advantage that new lamp 66 is already electrically assembled in an operative unit and is optically aligned with the optical axis of reflector 274. Such easy field replaceablity has a high value in search and rescue equipment.

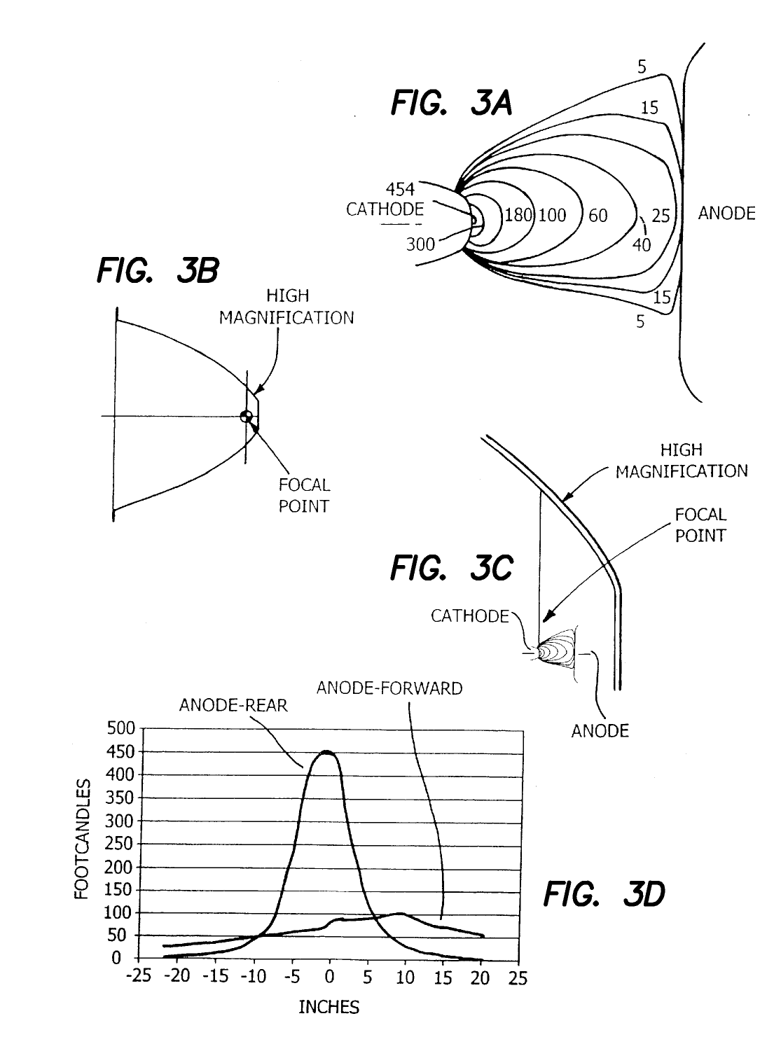

With lamp anode 256 uniquely oriented toward the rear or light housing 232 away from reflector 274, it is been determined that the field of illumination from lamp 66 is slightly convergent in the far-field and much more concentrated with conventional xenon arc lamps than would occur if the direction or orientation of the lamp were reversed, i.e. with the cathode in the rearward condition. This is due to positioning the full luminance distribution of the arc (FIG. 3a) in the high magnification (behind the focal point, FIG. 3b) section of the parabolic reflector (FIG. 3c), instead of in the low magnification for prior art anode-forward configurations. The resulting illuminance is significantly greater than in anode-forward, as shown in FIG. 3d. Hence with the lamp anode 256 in the rear position as shown in FIG. 5, a hole in illumination or lessening of variation of intensity in the central part of the spot or beam is reduced.

The anode-to-the-rear orientation also means that more heat is projected back into the searchlight toward circuit board 248. Finned heat sink 278 is provided and thermally connected to lamp housing 272 to ameliorate this condition. A metal heat sink block 235 shown in FIG. 5 is coupled to circuit board 234 to make thermal contact with fluted heat sink 274 by means of a pair of fingers 273. Fingers 273 clasp a mating internal heat sink flange (not shown) of heat sink 278.

Reflector housing 284 has an internal collar 287 provided with threading 288. Threading 288 engages threading 290 defined in the outer cylindrical extension of lamp base 272. Thus, when assembled into housing 232, reflector housing 284 screws onto lamp base 272 to further control the accuracy of rotation, as shown in FIG, 4 A tight tolerance sleeve and ring are used to stabilize the rotation. Reflector 274, which is described below, is attached to reflector housing 284, and thus may be longitudinally advanced or retracted along this longitudinal axis by rotation of reflector housing 284. The longitudinal axis of reflector housing 284 is coincident with the longitudinal axis or optical axis of 274. This allows for variable coincident of the beam of light.

Reflector 274 is disposed in reflector housing 284 so that forward flange 291 of reflector 274 abuts a shoulder 292 of reflector housing 284 as shown in FIG. 2. Reflector 274 is attached to reflector housing 284 by means of an adhesive sealant. Screws 294 connect reflector housing 284 to a bezel 298. Thus, bezel 298 thereby clamps a front transparent (or special ultraviolet, colored or infrared filter) faceplate 299 against a gasket 300, reflector 274 and shoulder 292 of reflector housing 284. A bezel ring 297 is threaded into an interior thread defined in bezel 298. Reflector housing 284 is completely sealed for water resistance and tempered glass window 299 is designed to be usable in hazardous environments. Reflector housing 284 and reflector 274 thereby rotate as a unit and are threaded onto lamp housing 272. An 0-ring and groove combination 303 is defined the exterior surface of reflector housing 284 to provide for water sealing. Reflector housing 284 as described above is threaded to lamp housing 272 which allows lamp 66 to be longitudinally moved and focused inside of reflector 274 as stated. Lamp housing 272 is fixed with respect to heat sink 278 and hence body 232 by means of two cupped set screws 310 shown in FIG. 6 threaded into heat sink 278 and bearing against lamp housing 272 which slip fits into heat sink 278. Thus, by loosening set screws 310, which have exterior access holes 312, the entire head assembly of searchlight 11 can be removed including lamp housing 272. Lamp housing 272 can then be unscrewed from reflector housing 284 and then replaced.

The rotation of reflector housing 284 about lamp housing 272 and hence heat sink 278 is better depicted in the perpendicular cross-sectional view of FIG. 7. Heat sink 278 has a finger which extends from one of the fins forwardly or to the right in FIG. 2 so that it is in interfering position with stops 316 screwed to and carried on reflector housing 284. Therefore, as bezel 298 is rotated by hand, thereby rotating reflector housing 284 with it, its rotation is limited to one revolution or slightly less by the interference between fixed finger 314 and rotating stops 316. In this manner the head assembly cannot be inadvertently unscrewed from lamp housing 272, and further the focus range of lamp 66 as it is longitudinally moved on the optical axis of reflector 274 is retained within a desired or optimal range.

Reflector 274 may be moved by hand as described by rotating reflector housing 284 or maybe adjusted by means of an electric motor or lever adjustment (not shown). The lamp is focused by positioning the arc gap in lamp 66 at the focal point of reflector 274.

Also included within bezel 298 may be a filter body carrying a filter (not shown) disposed on or adjacent to faceplate 299. The filter body screws into an interior thread defined in the inner diameter of bezel 298 or may be damped between bezel ring 297 and bezel 298. Filters may be chosen according to the purpose desired for providing a effective spotlight in smoky conditions, for ultra violet radiation, infrared radiation or for selecting a frequency band of illumination effective for underwater illumination. Filters may also be employed for attenuation of light intensity in lower illumination applications, such as often occur hi infrared applications.

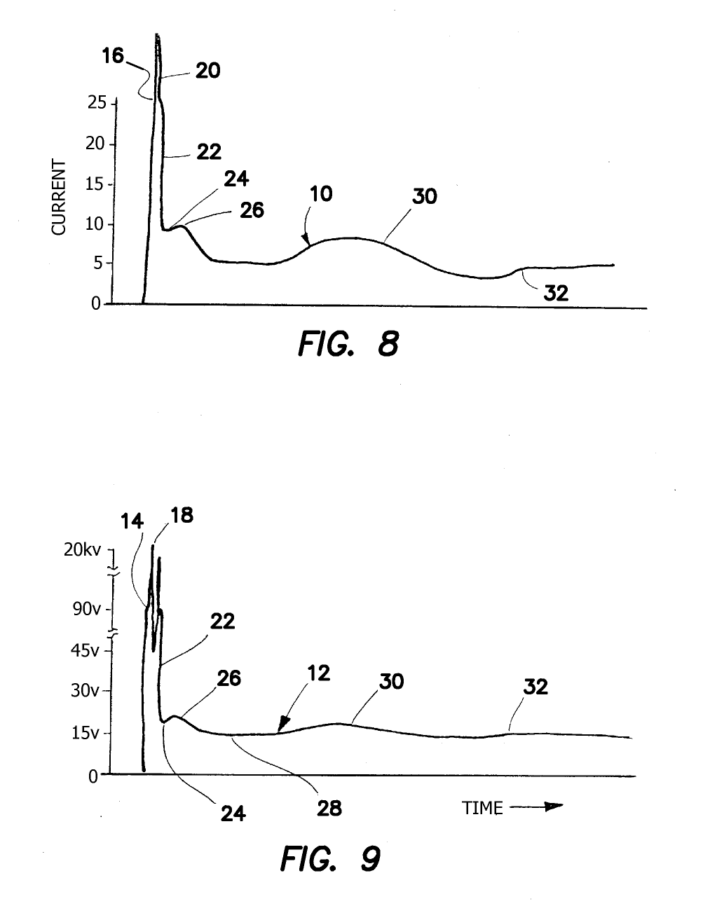

The present invention provides a unique circuit topology for providing the current and voltage necessary to ignite, sustain and to adjust the operation of an arc lamp and in particular a xenon lamp in a portable, hand-held battery operated light. The challenge is to provide the current and voltage requirements necessary to ignite and sustain an arc lamp from a wide range of the supply input voltage. Therefore, before considering the circuitry of the invention consider the typical current and voltage requirement xenon arc lamp graphically depicted in FIGS. 8 and 9 as a function of time.

FIG. 8 is a graph of the current supplied to a xenon lamp as a function of time, while FIG. 9 shows the graph of the voltage as a function of time. FIGS. 8 and 9 are aligned with respect to each other so that equal times appear at equal positions on the x-axis of each graph. Curve 10 of FIG. 8 illustrates the current of a xenon lamp while curve 12 in FIG. 9 illustrates the voltage. The lamp is turned on at time t=0. The power supply, described below turns on and rises quickly, i.e. within about 2 milliseconds, to provide a 90 volt dc open circuit voltage across the lamp at time 14 in FIG. 9. In the illustrated embodiment a 20 kilovolt RF pulse is generated at time 18 shown in FIG. 9 to start ignition of the lamp. The power rises rapidly to 100-125 watts. In the illustrated embodiment the RF pulse is about 400 kHz although many other frequencies and range of frequencies can be utilized without departing from the scope of the present invention, Typically the lamp is ignited within a short time, about one millisecond or less during which the current quickly falls as shown by falling edge 20 in FIG. 8. During this time a current is delivered from a storage capacitor at time 22 to deliver additional energy to heat the plasma and lamp electrodes in order to sustain its operation.

As will be described below, a converter circuit holds the heating power at time 24 in FIG. 9 to deliver the additional current. Once the lamp is started the converter may deliver a constant or regulated current to the lamp at any power level, although typically most lamps are only stable within the range of plus or minus 15 percent of the rated lamp current beginning at time 28 in FIG. 9. According to the invention, the lamp is started at an optimal power level for the lamp in question. From this point forward the current supply to the lamp and the intensity of its light output can be smoothly transitioned to any level within an operational range without visually perceptible stepped transitions or altered in a step change manner. For example, in the illustrated embodiments the user may manually manipulate the controls as described below to increase the current to a maximum power and brightness at time 30 in FIG. 9, thereafter at a later time smoothly decreasing the current and brightness of the lamp to a minimum power level at time 32 in FIG. 8.

The general time profile of the current and voltage of the xenon lamp through its phases of operation now having been illustrated in connection with FIGS. 8 and 9, turn to the schematic diagram of FIG. 10 wherein the pulse width modulator (PWM), converter, lamp circuit and igniter are illustrated. FIG. 10 is a simplified circuit schematic which illustrates the essential operation of the invention. It must be understood that many conventional circuit modifications for electromagnetic interference (EMI), circuit spike protection, temperature compensation and other conventional circuit modifications could be made in the circuit of FIG. 10 without departing from the spirit and scope of the invention.

The converter, generally noted by reference numeral 34, is controlled by a signal, PWM, on input 36. Input 36 is coupled to the gates of a pair of parallel FET'S 38 and 40 through an appropriate biasing resistor network, collectively denoted by reference numeral 42. The parallel FETs 38 and 40 contribute to the high efficiency of the circuit which results in a high conversion of the battery power to useful illumination. A light made according to the invention produces a beam twice the distance as conventional lights or xenon searchlights running at the same power.

The source node of transistors 38 and 40 are coupled to node 44 which is coupled to the input of diode 46 and to one side of inductor 48. The opposing side of inductor 48 is coupled to the supply voltage, +VIN 50. Also coupled between supply voltage 50 and the output of diode 46 is a storage capacitor 52. Energy is stored in capacitor 52 from converter 34 and is delivered as additional energy to heat the plasma and lamp electrodes to sustain its operation as was described in connection with FIGS. 8 and 9 in connection with time 26.

Node 54, also coupled to the output of diode 46 and one end of capacitor 52 is the voltage of the lamp power supply, VSENSE+. The current of the lamp power supply is measured by measuring the voltage drop across resistor 56 and is designated in FIG. 10 as the signals I SENSE+ and I SENSE−. The converter or power supply output is thus formed across nodes 54 and 58 and is delivered to a bank of filtering capacitors, collectively denoted by reference numeral 60, The lamp DC ground is thus provided at node 62 while the filtered converted lamp power is provided at node 64.

Xenon arc lamp 66 is coupled between lamp ground 62 and a lamp high voltage node 67. The lamp current supply from node 64 is coupled across the secondary coil of transformer 68. The primary of transformer 68 is coupled to the igniter, generally denoted by reference 70. The igniter takes its input from a signal, TRIGGER DRIVE 72, which is a 40 kHz signal which is ultimately communicated to the gate node of igniter transistor 74 in a manner described below. Igniter transistor 74 is coupled in series with the primary of transformer 76, The secondary of transformer 76 is coupled to diode 78 and then to an RC filter 80 for deliverance of a high voltage RF signal to a spark gap 82. When the voltage has reached a pre-determined minimum, the current will jump the spark gap 82, and current will then be supplied to the primary of transformer 68. In this manner, the 40 kHz RF pulse which is generated to start the ignition of lamp 66 is delivered to lamp high voltage node 67.

Before considering further the circuit used for the high voltage RF trigger communicated to the gate of transistor 74, consider first how the current to lamp 66 is controlled through PWM 136, which in the illustrated embodiment is a Unitrode model UC3823 pulse width modulator. Understanding how this is achieved will then facilitate an understanding of the control of the ignition trigger. One of the main problems to light a xenon lamp has been the initial ignition phase. In the past a high voltage is applied across the lamp (approx. 100 volts), the gas is ionized with a high voltage RF pulse (>10,000 volts) and a large capacitor is used to supply the energy to heat the plasma before reaching the normal running voltage which is about 14 volts for a 75 Watt lamp.

When using a switching power supply to run lamp 66 the conventional configuration is to use a “Boost Converter”, that is to boost the 12 volts from the battery supply to the running voltage of the lamp. The problem with this type of power converter is that the input voltage must be lower than the output voltage. This causes problems with the operation in many conventional automobiles for example, as the normal battery voltage can be over 14 volts. In the system of the invention an “Inverted Buck-Boost Converter” is used. This allows the converter to supply the proper lamp voltage while the input voltage can be anywhere from 10 to 28 volts.

In a conventional system, the starting high voltage is generated by running the converter in open loop and fixing the voltage to about 100 volts by setting the converter to a fixed duty cycle. This voltage also charges the capacitor that supplies the heating energy. The problem with this is that the converter must also supply power during the heating phase. During this heating phase the converter must supply more power than the running power for a short time. Because the duty cycle is fixed, changes in the input voltage will cause large changes in the power being supplied during this phase. A 10% increase in input voltage could cause, for example, the converter to try to supply more power than it is capable of producing. This will cause it to shutdown due to excessive current demand. The reverse, namely a 10% lower voltage in the input supply voltage, causes the converter not to supply enough power thereby causing the lamp not to light, The other problem is the converter must change from open-loop to closed-loop control to regulate the power being supplied to the lamp.

In the system of the invention, the heating power is semi-regulated by sensing the input voltage being supplied and adjusting the open-loop duty cycle. This relationship from voltage to duty cycle is not a one-to-one relationship. By using a percentage of the input voltage to adjust the RC time constant the resultant power delivered to the load will remain constant.

Turn again to FIG. 10 for a concrete illustration of this principle. The input voltage, +VIN, on one side of resistor 157 together with the fixed voltage supplied on resistor 163 (here shown as +10 volts) is summed at the junction 161 of resistors 157, 163, and 159. This summed voltage is the slope and offset adjusted voltage and is used to set the minimum duty cycle. Capacitor 145 filters this signal and provides a low pass filter. Resistors 159 and variable resistor 163 with capacitor 143 provide the RC time constant for the circuit, which is presented at node 147. Node 147 is coupled to current shutdown pin (ILIM/SD) on PWM 136. When the PWM output drive 36 coupled into FETs 38 and 40 is high, the RC circuit just described charges. When a predetermined threshold voltage is reached the PWM signal is turned off. This will keep the power constant across lamp 66 during the heating phase over the total operating input range of the supply from 10 to 32 volts.

When PWM drive 36 is low, capacitor 143 is reset through voltage discriminator 149 coupled to the gate node of transistor 151. When transistor 151 is turned on by discriminator 149, capacitor 143 is discharged to ground. Discriminator 149 is active high whenever PWM 36 drops below the reference voltage provided at the other input to discriminator 149, which in the illustrated embodiment is +5.1 volts. When PWM 36 goes high, the RC node 147 begins to charge and voltage on node 147 rises until it reaches a fixed threshold. At this point PWM 136 turns off PWM drive 36 and the cycle repeats. A percentage of the input supply voltage, +VIN, is coupled through resistors 157, 159, and 163 and is used to adjust the RC time constant at node 147 so that the resultant power delivered to lamp 66 remains constant even when there is a wide variation in the supply voltage. Variations in the DC power supply between 11 to 32 volts is easily accommodated by the claimed invention.

Consider now the circuitry used to provide the trigger to ignition transistor 74. Analogous circuitry is used to control the ignition trigger as was just described for the control of PWM drive 36. Resistors 157a, and 163a coupled to capacitor 145a perform the same function and form the same circuit combination as resistors 157, and 163 coupled to capacitor 145. Node 161a where resistors 157a, and 163a and capacitor 145a are coupled together is in turn coupled to resistor 159a and capacitor 143a which perform the same function and form the same circuit combination as resistor 159 and capacitor 143. The ignition signal, TRIGGER, is coupled to the gate of transistor 151a which in turn discharges RC node 147a in a manner as previously described in connection with PWM drive 36. TRIGGER is generated by programmable Magic device (PLD) 164 described below.

RC node 147a is coupled to one input of voltage discriminator 200, whose other input is coupled to a reference voltage, i.e. +2.5 V. In this way a threshold value is set for TRIGGER. When TRIGGER is not active, RC node 147a charges up and when the threshold is exceeded will be output from discriminator 200, filtered by filter 202, signal conditioned by inverters 204 and provided to the gate of transistor 74, the driver to the primary of the ignition transformer 76. When TRIGGER goes active, RC node 147a is discharged and the output of discriminator 200 is pulled to ground through pull-down transistor 206. Again, a percentage of the input supply voltage, +VIN, is coupled through resistors 157a, 159a, and 163a and is used to adjust the RC time constant at node 147a so that the resultant power delivered to lamp 66 during ignition remains constant even when there is a wide variation in the supply voltage.

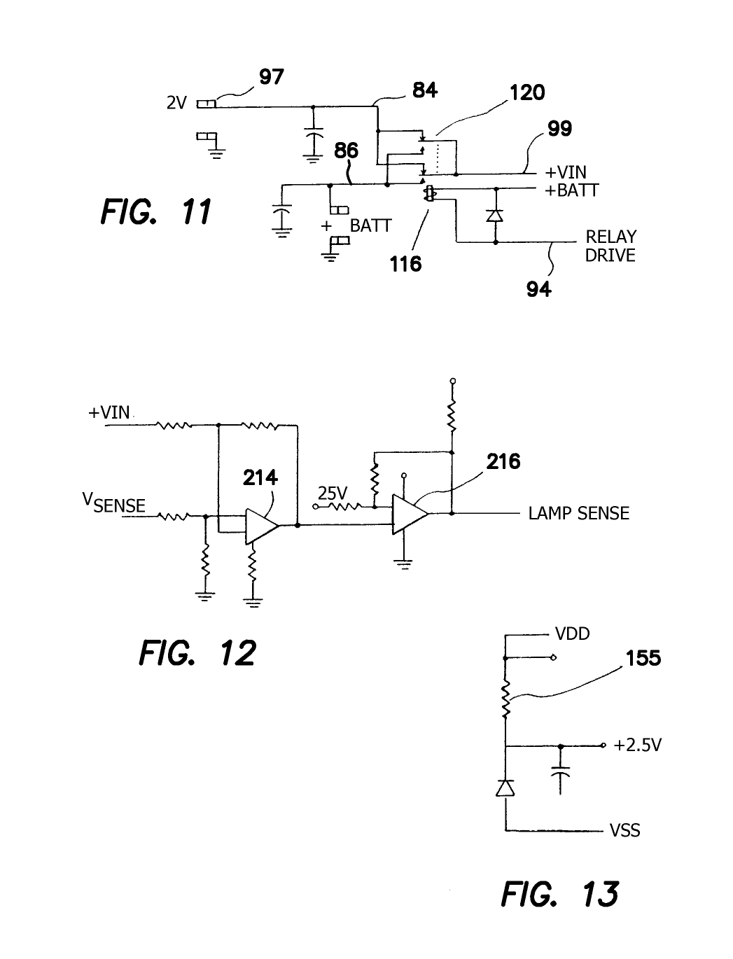

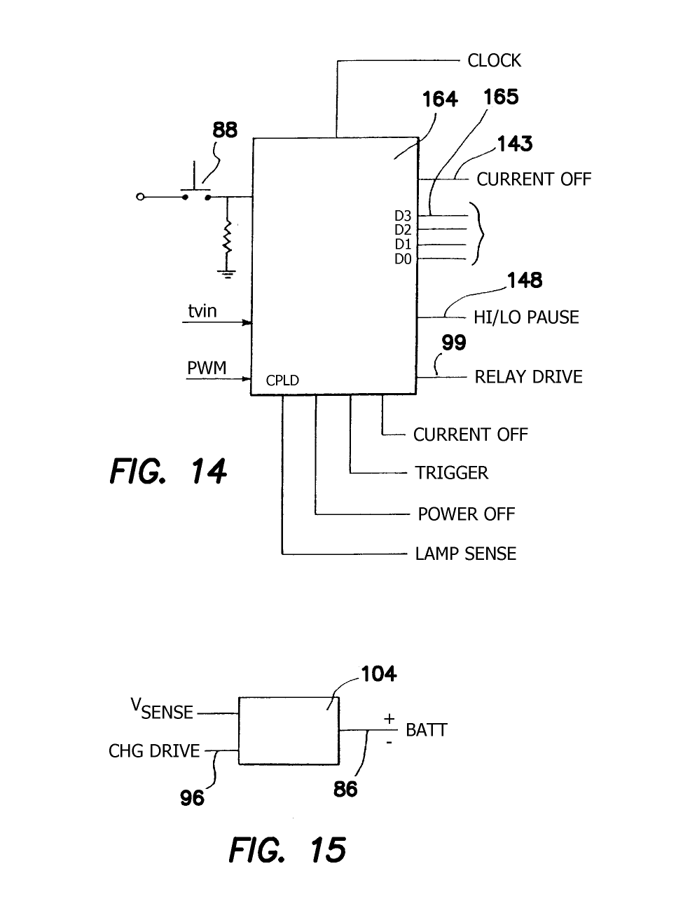

Consider now the power supply for converter 34. The searchlight may be powered either by an external 12 volt power supply provided line 84 shown in PG. 11 or by the current from an internal battery, +BATT, line 86 of FIG. 11. The manual operation of the lamp is provided by means of a closure of a push button switch 88 shown in FIG. 14 which is used to provide a grounded signal, RELAY DRIVE from PLD 164. When RELAY DRIVE goes active, relay 116 is energized and the supply voltage., +VIN, on line 99 is switched to the internal battery, +BATT. When RELAY DRIVE goes inactive, relay 116 is de-energized and the supply voltage, +VIN, is switched to an external terminal 97. Either an externally provided power supply signal or the battery power supply is provided by means of control of a double pole-double throw relay 116 powered by the signal, RELAY DRIVE, on line 94. Contacts 120 of relay 116 thus either provide an exterior power supply voltage 122 or the battery voltage, +BATT, as the circuit power supply 50, +VIN.

FIG. 15 illustrates the circuit for a battery charger controller 104 provided within the searchlight to charge the battery. A signal, CIG DRIVE, is provided from PLO 164 on input 96 to the gate to controller 104. The signal, SENSE+, from node 54 is also coupled as an input to controller 104 from converter 34. Battery charger controller 104 is a conventional integrated module.

The converter and igniter circuitry and battery supply current now having been described, turn to the control circuitry of FIG. 10. The current sensing nodes 58 and 59, I SENSE − and I SENSE+ respectively, are provided as inputs to a transconductance amplifier 124 which is characterized by high impedance and provides an amplified voltage output to the input of diode 126. In the illustrated embodiment a Maxim high-side, current-sense amplifier model 472 is used. The output of diode 126 is fed back on line 127 to node 132. The voltage at node 132 is provided through resistor 134 to the inverted input pin, INV, of pulse width modular 136. Pulse width modulator 136 produces from its various inputs a PWM drive 36 which was described above as being coupled to the input of converter 34, The other inputs and outputs of pulse width modular 136 are conventional and will thus not be further described unless relevant.

The signal provided on node 132 is affected by several adjustments. Node 132 is resistively coupled to transistor 142 whose base is controlled by control signal, CURRENT OFF, also output from PLD 164. Thus, when transistor 142 is turned on, node 132 is pulled low. This causes PWM drive 36 to go low.

Node 132 is also resistively coupled to ground through transistor 144 whose base is resistively coupled to a control signal, HI LO POWER as provided by PLD 164. The emitter of transistor 144 is coupled to node 132 through a conventional binary coded decimal (BCD) resistive ladder 146 so that the maximum current on node 132 is continuously and smoothly digitally controlled as it is adjusted from high to low power and vice versa. Binary coded decimal (BCD) resistive ladder 146 is controlled by the BCD output 165 from PLD 164 so that the amount of resistance provided by ladder 146 is digitally controlled and varied in amounts which are visually imperceptible when hi/lo power is active.

The control signal to input NOT INVERTED (NI) of pulse width modulator 136 is controlled through an adjustable resistive network, collectively denoted by reference numeral 150. The control signal E/A OUT of pulse width modulator 136 is similarly provided from a filter network 152 for the purpose of rejecting unwanted frequencies. The control signal 153, (ILM REF) is similarly provided from a biasing network 154 with the purpose of setting the threshold voltage at which RC node 147 will cut off PWM drive 36. A CLOCK signal is provided from pulse width modulator 136 to PLD 164 for the purposes of docking programmable logic device 164 shown in FIG. 14.

The lamp high voltage set point is produced in part by the circuitry of FIG. 12. High voltage from node 54, V SENSE+, is resistively provided to the input of differential amplifier 214. The opposing input of amplifier 214 is resistively coupled to the supply voltage +VIN, and the output of feedback amplifier 214 is then provided to one input of differential amplifier 216 whose other output is coupled to the +2.5 volt reference. The output of feedback amplifier 216 is the command signal +LAMP SENSE, which is provided as one of the inputs to PLD 164 and which provides a feedback signal of what the voltage on lamp 66 is.

The control of light intensity and many other lamp control functions are provided by PLD 164 which is a conventional programmable logic device such as model XC9572 manufactured by Xilinx. The programming of PLD 164 is conventional. The input signals to PLD 164 include CLOCK, +VIN, +LAMP SENSE and PWM, while the output signals are CURRENT OFF, RELAY, TRIGGER, Hi LO POWER whose functions are described above. Push button 88 is programmed in PLD 164 so that a momentary depression of push button 88 turns on the light. A second momentary depression of push button 88 turns off the light. However, when push button 88 is turned on and held on for more than a few seconds, HI/LO POWER goes active and BCD signals 165 begin to count up causing resistance ladder 146 to be driven to gradually increase the power. As long as button 88 is held down, BCD signals 165 count up and light intensity increases. As soon as button 88 is no longer depressed, counting stops and the light intensity remains fixed. If the light is turned off and then turned on again, it will light at the light intensity that was last chosen. The BCD signals 165 count cyclically, i.e. after reaching the maximum count, BCD signals 165 return to the minimum count and hence minimum light intensity. The cycle is then repeated. If desired, PLD 164 could also be programmed to count down or in the opposite direction of light intensity variation. Push button 88 can be programmed in PLD 164 in many different ways from that described without departing from the spirit and scope of the invention.

FIG. 13 is a schematic which shows a conventional manner in which the 5.0 and 2.5 volt reference signals are respectively generated using resistor divider 155.

The circuitry now having been described in detail, several observations can be made. The circuit, as previously stated is markedly more efficient in producing light from lamp 66 than prior circuits. This is due to several factors. First, the use of parallel switching FETs 38 and 40 described above contributes to increased power conversion efficiency into light output. Second, the use of a high voltage battery may contribute. Typically, battery voltages of 12 volts are employed, In the present invention batteries with outputs in the range of 16-22 volts are used. Third, converter 34 is run at a higher switching frequency. Whereas prior circuits are operated at about 20 kHz, the present invention is configured to drive converter 34 at a much higher frequency, such as 100 kHz.

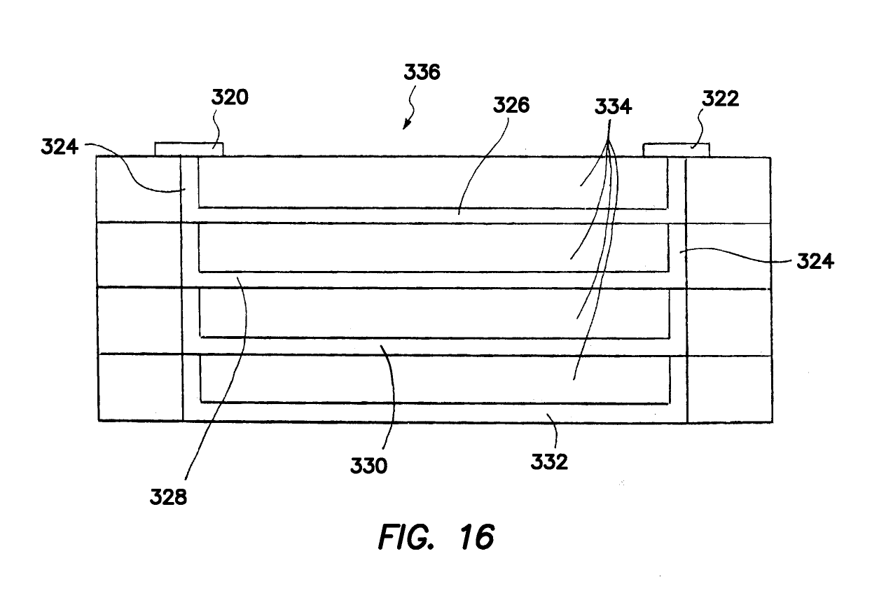

Finally, the circuit boards are laid out and fabricated to minimize power losses in the lines. A four layer printed circuit board is used. In high current lines such as the circuit path from +VIN to node 50, inductor 48 and FETs 38 and 40, and in the power lines in FIG. 11, lines 97, 84, 120, and 86, multiple printed circuit board lines are fabricated in parallel for the same line on the schematic. For example, in each of the lines just mentioned four parallel printed circuit board lines are fabricated and coupled in parallel with each other as shown in FIG. 16. For example, pads 320 and 322 diagrammatically represent nodes in the circuit between which a high current occurs. The circuit board, generally denoted by reference numeral 336, is comprised of four layers 334. A vertical riser or via 324 is defined from pads 320 and 322 through all four layers 334. Vias 324 are coupled with wide and thick conductive printed circuit lines 326, 328, 330 and 332 disposed on the bottom of each of layers 334. Circuit lines 326, 328, 330 and 332 are in parallel circuit with each other and therefore provide a very low resistance, low loss line for high current loads.

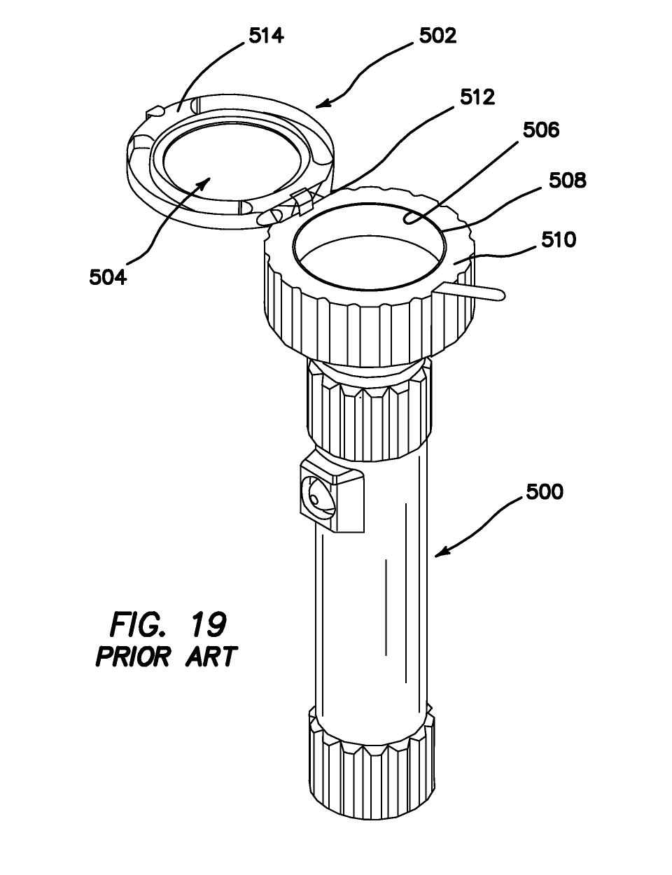

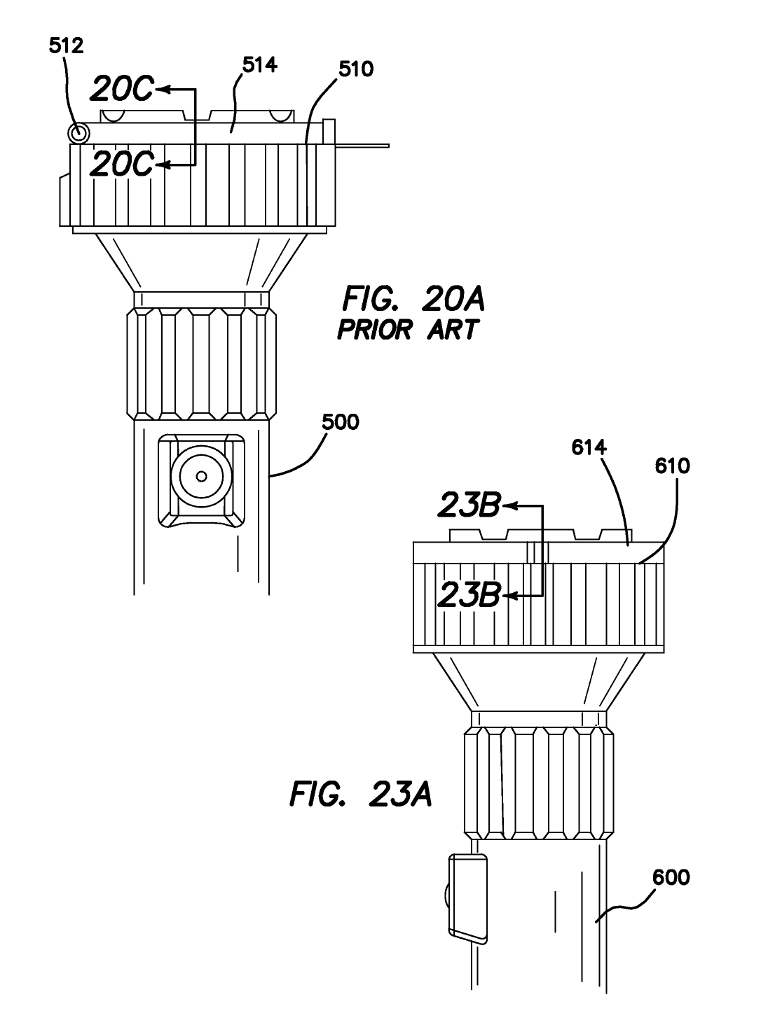

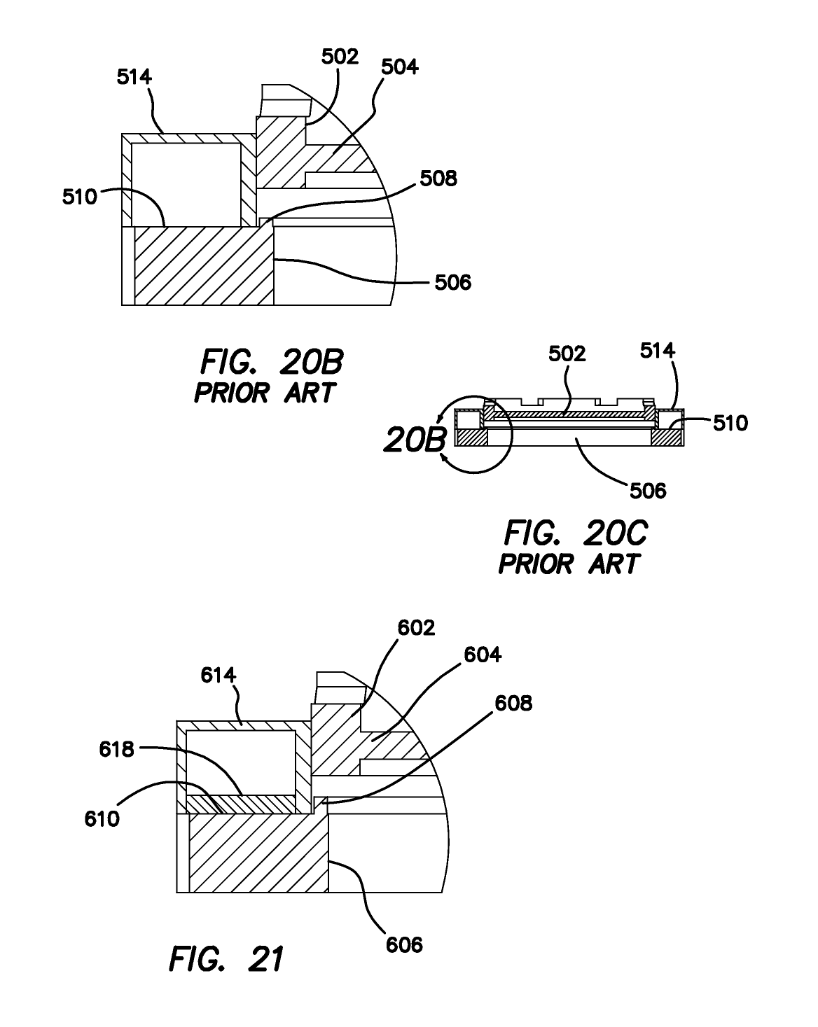

FIG. 19 is a perspective view of the prior art NightHunter 3 referenced above showing a flashlight or torch body 500 having an aperture 506 through which the white light of the torch 500 is directed. Aperture 506 is provided with a circumferential flange 508 which extends above end surface 510 by not more than 0.9 mm and is intended to provide a light curtain around filter 502 when filter 502 is in the fully closed configuration. A conventional IR filter 502 is coupled to surface 510 by a top mounted hinge 512, which allows filter 502 to rotate from the fully open position shown in FIG. 19 to the fully closed position shown in FIGS. 20a-20c. IR filter 502 includes a circular frame 514 in which is mounted a planar IR filtering element 504. Further rotation of frame 514 when in the open position backward beyond that depicted in FIG. 19 is prevented by the construction of hinge 512 atop surface 510 by the interference of surface 510 with the upper surface of frame 514 which is rotated against it.

FIG. 20a illustrates a side elevational view of the upper portion of the NightHunter 3 with the filter 502 fully closed against surface 510. A cross-sectional view taken through lines A-A of FIG. 20a is shown in FIG. 20c and the detail in region B is enlarged in FIG. 20b. There the overlap of flange 508 included within the closed frame 514, when frame 514 is flatly and intimately closed against surface 510, is illustrated. The intended result is that light radiating through aperture 506 into filter element 504 is provided with a light curtain provided by flange 508 so that there is no white light leakage between surface 510 and frame 514. However, the reality is that any inclusion of grains of sand, dirt, small rocks or debris of any kind between the mating surfaces frame 514 and surface 510 will cant the IR filter 502 upward, particularly if the included material is in the vicinity of the hinge 512. Since torch 500 is primarily employed in law enforcement and military applications, it is usually employed in dirty environments where such sand, dirt, small rocks or debris can be expected to become smeared over all surfaces of torch 500. Substantial light leakage occurs then when filter 502 is rotated into its closed configuration for IR clandestine or unobserved operation with the result that the use of the torch 500 becomes easily detected.

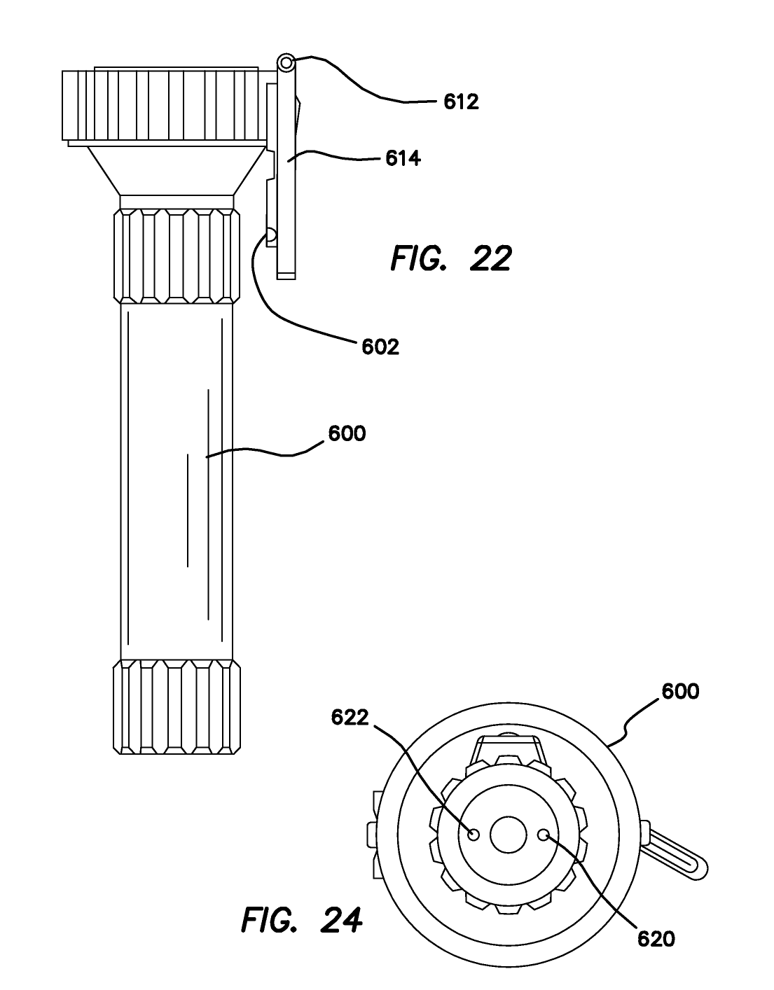

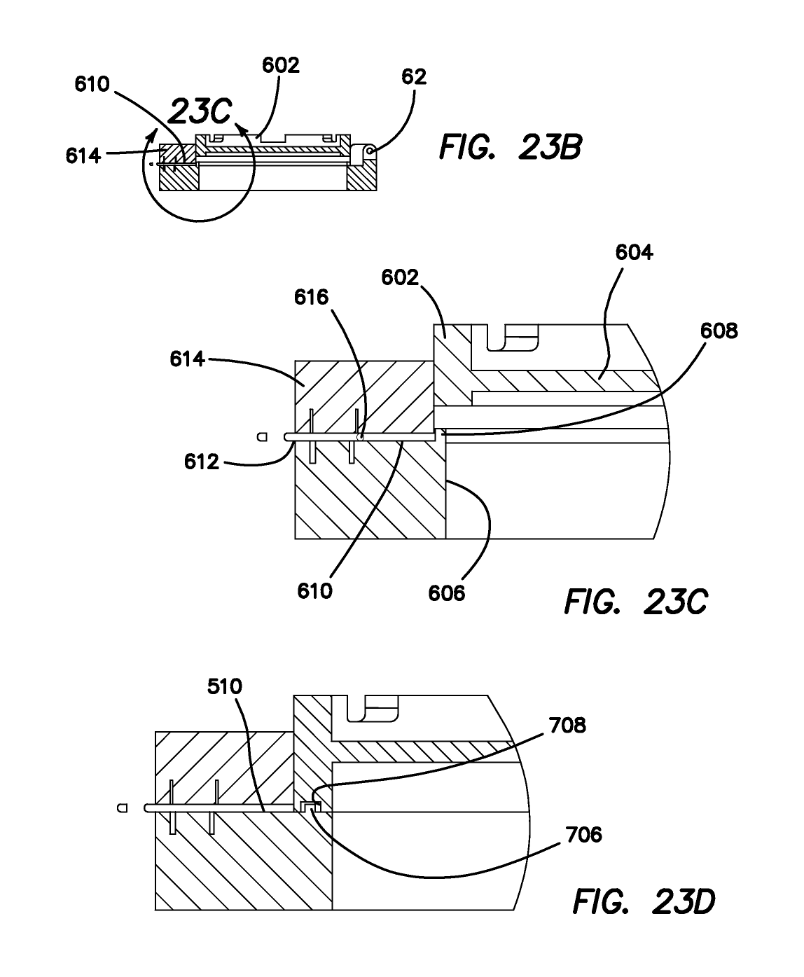

The improved illustrated embodiment is depicted in the side elevational view of FIG. 23a corresponding to FIG. 20a and in the side cross-sectional view of FIG. 23b taken through section lines C-C of FIG. 23a corresponding to FIG. 20c and as best seen in the enlargement of FIGS. 21 and 23c corresponding to FIG. 20b. FIG. 21 shows a portion of the frame 614 which is hollow between the hinge 612 and are opposing catch and FIG. 23c shows a cross-sectional view at the vicinity of hinge 612. Turning to FIG. 23c it can be seen that circumferential flange 608 corresponding to flange 508 of FIG. 20b has been increased in height and extends substantially higher over surface 610 than flange 508 extends above surface 510, namely flange 608 has a height of at least 1.5 mm compared to 0.9 mm of FIG. 20b. FIG. 23c shows sand, dirt, small rocks or debris 616 included between surface 610 and frame 614, However, as shown in FIG. 23c flange 608 still completely blocks any gap or crack created by sand, dirt, small rocks or debris 616 and provides an effective light curtain. The height of flange 608 is chosen so that most of the sand, dirt, small rocks or debris 616 which could be normally expected to be smeared on surface 610, particularly in the vicinity of hinge 612, and still be small enough to adhere to surface 610 or frame 614, will fail to cause frame 614 to be canted enough from surface 610 to open a gap or crack greater than the height of flange 608.

FIG. 23d is a depiction of another embodiment wherein the light trap is provided by a circular ridge 706 defined on the end surface 510, which is disposed into a circular groove 708 defined into frame 514 in an open tongue-in-groove configuration. In the illustrated embodiment ridge 706 is 1.5 mm in height above surface 510 and 2 mm wide. Groove 708 is 2 mm deep and 4 mm wide so that ridge 706 is easily disposed therein without interference, but with ridge 706 extending a substantial fraction of the distance into groove 708, namely in this embodiment approximately 50% of the depth of groove 708. Note that since light travels only in a straight line, the labyrinthian path provided by the light trap of groove 708 and ridge 706 requires multiple reflections for any light to escape the trap. The surfaces of groove 708 and ridge 706 are provided with a flat black or nonreflective finish, so that the reflection coefficients are negligible.

FIG. 22 illustrates another advantage of the improved embodiment wherein hinge 612 is constructed to be cantilevered radially outward from surface 610, so that IR filter 602 is rotated into the open position, it is not stopped by interference with frame 614 to a projecting inclination away from torch 600, such as shown for the NightHunter 3 in FIG. 19, but is able to assume are more aligned or folded-back configuration with the body of torch 600.

As diagrammatically depicted in FIG. 21 frame 614 is provided with a permanent magnet 618 mounted in frame 614 which securely attaches to the ferromagnetic or paramagnetic surface 610 to provide an unobtrusive latch, which automatically engages and releasably maintains IR filter 602 in the closed configuration whenever frame 614 is rotated to the closed position. In the case where surface 610 is composed of nonferrous or nonparamagnetic material, a corresponding permanent magnet can be inset into an opposing location into surface 610.

FIG. 24 illustrates another advantageous feature of the improved embodiment over the NightHunter 3. In the bottom plan view of torch 600 two LED indicator lights 620 and 622 are provided in the bottom surface of torch 600. Indicator light 620 is connected to the control circuitry within torch 600 and is lit whenever the torch is operational, i.e. when the main white light source is operating. Light 620 may be red in color for example. Thus, the user knows then by observing a red light 620 that when IR filter 602 is in the fully closed condition, and it cannot be detected by the human eye whether the light is actually on or not, that torch 600 is operating and the IR filter 602 cannot be opened without flooding the scene with white light. The companion light 622 is a battery charge condition light and may, for example, be colored yellow and lit whenever torch 600 has a low charge on it or is discharged.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter s viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. An apparatus for producing a high intensity beam of light with high efficiency of conversion of electrical power into light intensity comprising:
an arc lamp;
a reflector;
a screw drive mechanism coupled between the arc lamp and reflector for positioning the arc lamp relative to the reflector to provide zoom control of the beam of light; and
a spring for biasing the screw drive mechanism into a stable configuration to eliminate backlash and instability of the positioning the arc lamp relative to the reflector to provide zoom control of the beam of light, and directional stability of the beam.

2. An apparatus for efficiently producing a high intensity narrow, substantially collimated beam of light which includes a user adjustable zoom comprising:
an arc lamp having a plasma which is characterized by a longitudinal arc in which the light is produced;
a reflector surrounding the lamp, the reflector having a longitudinal optical axis and a focal range from which light is reflected within a predetermined range of collimation of the beam of light, the plasma of the arc lamp being positioned on the optical axis within the focal range;
a threaded coupling between the lamp and reflector so that longitudinal position of the reflector relative to the arc lamp is adjustable while in use; wherein the reflector is longitudinally displaceable relative to the lamp by means of rotation about the threaded coupling so that the reflector is longitudinal displaced along the optical axis while maintaining the plasma of the lamp on the longitudinal optical axis within the focal range, a lamp housing and wherein the lamp is fixed within the lamp housing, the reflector being coupled to the lamp housing and longitudinally displaceable with respect to the lamp housing; the lamp housing having a shoulder in sliding juxtaposition with the reflector to maintain the reflector on the longitudinal optical axis as the reflector is longitudinal displaced by means of rotation about the threaded coupling; and
a spring for biasing the threaded coupling into a stable configuration to eliminate backlash and instability of the positioning the arc lamp relative to the reflector to provide zoom control of the beam of light.

3. The apparatus of claim 2 wherein the reflector has a direction of projection of the beam of light and wherein the lamp has an anode and a cathode, the anode being oriented on the longitudinal optical axis relative to the cathode so that the anode is rearwardly positioned in the reflector relative to the cathode and the direction of projection of the beam of light by the reflector.

4. An apparatus for producing an adjustable high intensity, narrow, substantially collimated which includes a user adjustable zoom beam of light comprising:
an xenon or metal halide arc lamp which is characterized by a short longitudinal arc;
a reflector surrounding the lamp, the reflector having a longitudinal optical axis and a focal range on the longitudinal optical axis from which light is reflected within a predetermined range of collimation of the beam of light;
a threaded coupling between the lamp and reflector; wherein the reflector is longitudinally displaceable relative to the lamp while in use so that the reflector is longitudinally displaced by means of rotation about the threaded coupling while in use and while maintaining the arc lamp on the longitudinal optical axis within the focal range;
a lamp holder having a shoulder in sliding juxtaposition with the reflector to maintain the reflector on the longitudinal optical axis as the reflector is longitudinal displaced by means of rotation about the threaded coupling; and
a spring for biasing the threaded coupling into a stable configuration to eliminate backlash and instability of the positioning the arc lamp relative to the reflector to provide zoom control of the beam of light.

5. An apparatus for producing a high intensity substantially collimated uniform beam of light comprising:
an arc lamp having a plasma which is characterized by a longitudinal arc in which the light is produced;
a reflector surrounding the lamp, the reflector having a longitudinal optical axis and a focal range from which light is reflected within a predetermined range of collimation of the beam of light, the plasma of the arc lamp being positioned on the optical axis within the focal range, wherein the reflector is longitudinally displaceable by user manipulation relative to the lamp so that the reflector is longitudinally displaced along the optical axis while maintaining the plasma of the lamp on the longitudinal optical axis within the focal range, wherein the reflector has a direction of projection of the beam of light, and wherein the lamp has an anode and a cathode, the anode being oriented on the longitudinal optical axis relative to the cathode so that the anode is rearwardly positioned in the reflector relative to the cathode and the direction of projection of the beam of light by the reflector, whereby the field of illumination of the beam of light is rendered more uniform; and
a spring for biasing the reflector and lamp into a stable relative configuration to eliminate backlash and instability of the positioning the arc lamp relative to the reflector to provide zoom control of the beam of light.

6. The apparatus of claim 5, wherein the apparatus is a light, further comprising:
a light housing to which the arc lamp is stationarily mounted;
a reflector housing to which the reflector is mounted;
a reflector positioner comprising a threaded coupling between the light housing and the reflector housing enabling longitudinal displacement of the reflector relative to the light housing by the user manipulation; and a fluted heat sink mounted on the light housing, wherein the housing conductively dissipates lamp heat from the anode.

7. A searchlight for producing a narrow, substantially collimated beam which includes a user adjustable zoom comprising:
a lamp which is characterized by a short longitudinal arc;
a lamp circuit coupled to the lamp for powering and controlling illumination produced by the lamp;
a reflector disposed about the lamp to reflect light generated by the lamp in a forward direction, and which reflector is characterized by a longitudinal axis extending rearwardly and forwardly;
a reflector positioner comprising a threaded coupling between the reflector and a housing of the searchlight so that the reflector is selectively displaced with respect to the housing by means of rotation about the threaded coupling while in use and while the lamp remains fixed relative to the housing; the lamp having an anode and a cathode, the anode being positioned rearwardly along the longitudinal axis relative to the cathode, whereby the field of illumination of the beam of light is rendered more uniform; and a fluted heat sink fixed on the housing to conductively dissipate lamp heat from the anode; and
a spring for biasing the thread coupling into a stable configuration to eliminate backlash and instability of the positioning the arc lamp relative to the reflector to provide zoom control of the beam of light.

8. A handheld light comprising:
a source of light including infrared (IR) and visible spectra;
a body having an aperture through which light from the source is transmitted;
an IR filter selectively disposable over the aperture so that only infrared light is selectively transmitted through the aperture; and
a circumferential light curtain interposed between the IR filter and the body so that when the IR filter is selectively disposed over the aperture, no light is able to leak between the IR filter and the body even when a granular object is disposed between the IR filter and the body and prevents close fitting between the IR filter and the body, the light curtain sufficiently extending between the IR filter and the body to block light from leaking between the IR filter and the body when the granular object is disposed between the IR filter and the body.

9. The handheld light of claim 8 where the body is characterized by a longitudinal axis and where the IR filter is coupled to the body by a hinge allowing rotation of the IR filter, the hinge being arranged and configured relative to the body to allow the IR filter to be rotated into an open configuration where the aperture is not covered by the IR filter and to be rotated into a position folded back toward the longitudinal axis of the body.

10. The handheld light of claim 8 further comprising a magnetic latch and where the IR filter is selectively maintained in a dosed configuration by the magnetic latch.

11. The handheld light of claim 8 further comprising a control circuit and an indicator lamp mounted on the body and coupled to the control circuit, the indicator lamp operative when the light source is lit, so that a user may determine by observation of the indicator lamp whether the light source is it even though the IR filter is disposed over the aperture and transmission of visible light therethrough is not otherwise detectable.

12. The handheld light of claim 8 where the circumferential light curtain comprises a tongue-in-groove combination.
